(19) United States
(12) Patent Application Publication
(10) Pub. No.: US 2006/0144793 A1
(43) Pub. Date: Jul. 6, 2006

(54) Novel adsorbents and process of making and using same

(76) Inventor: Mazakhir Dadachov, Mahopac, NY (US)

Correspondence Address: CORPUSCULAR, INC., 52 PAPANIA DRIVE, MAHOPAC, NY, 10541, US

(21) Appl. No.: 11/177,859

(22) Filed: Jul. 8, 2005

Related U.S. Application Data
(60) Provisional application No. 60/587,636, filed on Jul. 13, 2004.

(51) Int. Cl. B01D 15/00; C01G 23/047

(52) U.S. Cl. 210/660; 423/610

(57) ABSTRACT

Adsorbents and Methods used for effective removal or concentration or retention and recovery of harmful or valuable dissolved ions and compounds from aqueous systems using quantum size effect on large band gap semiconductors are provided. This invention provides methods for creating surface hydroxyl groups on surfaces of anatase, brookite and rutile large band gap semiconductors which comprise methods of reducing dimensions of individual crystals to the sizes where surface hydroxyl groups are self generated via quantum size effects when they contacted with electrolytes. This invention also provides methods of reproducible preparation of quantum sized effected anatase, brookite and rutile, which comprise in non-batch and continues process in which growth of said crystals is aborted. The invention also provides methods using quantum size effected anatase, brookite and rutile products for treatment of water, comprising rapid and high capacity adsorption of dissolved molecules and ions to the surface of said crystals via surface reaction process between said effect created hydroxyl groups with molecules and ions. Invention in general provides an effective means for treatment of water from harmful contaminants, especially As, P, U, transuranic elements, W, Mo, Cu, Pb, Cd, Co, Ni, Cr and others

### CROSS-REFERENCE TO RELATED APPLICATION

This application claims of the benefit U.S. Provisional Application No. 60/587,636 filed on Jul. 12, 2004, the content of which is hereby incorporated by reference in its entirety into the subject application.

### FIELD OF THE INVENTION

The present invention relates to novel inorganic adsorbents and methods of preparing and using same for removing or concentration or retention and recovery of harmful or valuable dissolved ions and compounds from aqueous systems. More particularly, the present invention relates to novel adsorbents and methods to implement the specific surface properties arising from quantum size effects on nanocrystalline wide band gap semiconductor titanium dioxides of anatase, brookite and rutile structures with crystallite sizes preferably is less than 100 Å and using same for the removal of dissolved contaminants from aqueous systems.

### BACKGROUND OF THE INVENTION

Crystalline binary inorganic oxygen compounds of titanium are well known. Structurally well characterized compounds among them are: first, stoichiometric titanium dioxides TiO₂ compounds anatase, brookite, rutile, non-stoichiometric titanium oxides for example Ti_{0.784}O₂ with anatase structure, non-stoichiometric titanium oxides for example Ti_{0. 912}O₂ with rutile structure; second, homologous series of various Magneli phases TiO₂ₙ₋₁ with 4<n<9; third, titanium monoxides Ti₁O₁, Ti₅O₅, defect structures based on cubic hongquiite structure; forth, titanium oxides containing hydrogen atoms: H₂Ti₃O₇ and other layered compounds obtained by ion exchange of alkali metal titanates. Hydrogen containing rutiles—Swope, R. J., Smyth, J. R., Larson, A. C. H in rutile-type compounds: I. Single-crystal neutron and X-ray diffraction study of H in rutile, American Mineralogist, 80, 448-453, (1995).

Amorphous compounds and compounds with ill-defined structures are also well documented in scientific and patent literature. Hydrous titanium dioxides are obtained by hydrolysis of salts and/or precipitation via addition of sodium or ammonium hydroxides. Hydrous titanium dioxides are prepared by mixing titanium salts with alkali. Similar hydrous titanium dioxides also obtained by hydrolysis of titanium alkoxides. The precipitates obtained are usually dried at room temperature or temperatures up to several hundreds degrees Celsius. Heating of amorphous precipitates up to 200° C. normally leads to loss of free or interstitial water and chemically bound water at higher temperatures. Infrared measurements show that the molecules of water are more or less bound to the solid, while the OH groups are bound to the titanium metal atoms. Hydrous titanium dioxides is expressed by the general formula: TiO₍₂₋ₓ₎(OH)₂ₓ yH₂O, where y is around 1. These hydrous and amorphous titanium dioxides are sometimes regarded as titanium hydroxides Ti(OH)₄, metatitanic acid H₂TiO₃, orthotitanic acid H₄TiO₄. However it has never been proven that these formulas are correct, as depending on synthesis method and drying conditions these precipitates could contain the different amounts of water which are not similar to those described by above chemical formulas.

Hydrous titanium oxides are amorphous and consequently they do not exhibit a long-range structural order. X-ray powder diffraction pattern of hydrous titanium dioxides does not have distinctive diffraction peaks. X-ray diffraction pattern of hydrous titanium dioxides, as well as those of compounds regarded as titanium hydroxides, metatitanic and orthotitanic acids are featureless or show one or two very broad humps instead of diffraction peaks with characteristic interplanar distances typical for crystalline compounds.

Since amorphous hydrous titanium oxides have hydroxyl groups attached to the titanium atoms, and since they can participate in surface reaction with cationic and anionic species in water, they have been considered for a long time as adsorbents. A considerable amount of research has been previously performed to develop amorphous hydrous titanium dioxides that can be used to bind the low concentrations of dissolved inorganic substances on their surfaces using these hydroxyl groups. Interesting and useful adsorbents for uranium, arsenic adsorption using these amorphous titanium dioxides have been developed. However, the surface hydroxyl groups on the surface of amorphous hydrous titanium oxides are random, occur in unpredictable quantities and more importantly they are formed and function differently from those described in present invention.

U.S. Pat. No. 6,383,395 discloses the use of powdered titanium hydroxide, packed in a column or applied to a filter in a form of a paste, to remove dissolved oxyanions, particularly arsenate, from water. References cited in this patent disclose that the powdered titanium hydroxide may be produced by hydrolysis of a titanium compound and precipitation of the resulting hydrolyzed titanium compound.

U.S. Pat. No. 5,618,437 discloses the use of a hydrous titanium oxide dispersed on the surface of a metal oxide supporting matrix to remove dissolved sulfate from a brine.

U.S. Pat. No. 5,227,053 discloses the use of anatase titanium dioxide coated plates for a point of use water purification system. The anatase form was found to be particularly effective. Also, different grades of TiO₂ give significantly different results although they all possess the same anatase form. That invention uses a grade of TiO₂, which has been found to be particularly effective and is sold by Degussa Corporation under trademark P-25™. In further description of our invention we will show that the P-25™ of Degussa and like, are particularly not suitable for our invention.

U.S. Pat. Nos. 4,268,399 and 4,304,687 teach the use of a zinc titanate catalyst to purify organically polluted water.

U.S. Pat. No. 4,892,712 discloses a purifier that uses U.V. irradiation to photoactivate a metal semiconductor used as a catalyst. The anatase form of titanium dioxide (TiO₂) is disclosed as preferred but other metal semi-conductors such as ZnO, CdS, WO₃ and SnO₂ are also stated as being useful.

TiO₂ catalysts have been bound to several different substrates, e.g., glass, inside of a glass tube and to small glass beads. Serpone et al. describes how TiO₂ has been prepared and simultaneously embedded onto 3-4 mm glass beads by high temperature decomposition of titanium (IV) alkoxides in alcohol media, “Photocatalysis over TiO₂ Supported on a Glass Substrate”, SOLAR ENERGY MATERIALS, 14:121-127 (North Holland Amsterdam 1986). The use of glass beads facilitated the subsequent separation of TiO₂ from the treated water. These glass beads were used many times over with no loss of TiO₂ from their surface and no apparent loss of catalytic properties.

R. W. Mathews, “Solar-Electric Water Purification Using Photocatalytic Oxidation with TiO₂ as a Stationary Phase”, SOLAR ENERGY, 38:405-413 (1987), described the practical performance of TiO₂ on a domestic water supply. He found that due to certain impurities in this water, the photoactivity of the catalyst decreased by 33% after 1700 liters had been treated. After only 20 or 30 liters, evidence of a yellow-brown discoloration began to appear on the catalyst surface.

U.S. Pat. No. 3,332,737 discloses the use of hydrous titanium oxides in packed columns to adsorb several dissolved metals. The hydrous titanium oxides are prepared by treating a solution of a hydrolysable titanium compound with aqueous ammonia or hydrogen peroxide.

Japanese Patent Application Publication 58-45705 discloses the use of hydrous titanium oxides in slurry to remove oxyanions, such as arsenate, from water at concentrations in the parts-per-billion (ppb) range. The hydrous titanium oxide adsorbent is prepared from a precipitate of a hydrolyzed titanium salt. It is noted in Publication 58-45705 that the kinetics of adsorption are relatively slow, and that a contact time roughly five times as long is required to remove the same amount of arsenate from solution in the absence of certain non-oxygenated acidic anions, such as chloride or sulfide, as when the acidic ions are present.

Japanese Patent Application Publication 57-150481 discloses the removal of arsenate from water by co-precipitation with hydrous titanium oxides. The co-precipitated solids are separated from the aqueous stream after the hydrolysis and co-precipitation reactions have proceeded to completion.

Japanese Patent Application Publication 53-122691 discloses the preparation and use of a composite adsorbent comprising a granular activated carbon and hydrous titanium oxides. The composite adsorbent is prepared by boiling the granular activated carbon in a concentrated solution of a titanium salt in the presence of an oxidative acid, then washing and air-drying the resulting adsorbent.

U.S. patent application Publication No. A1 20030155302 Methods of preparing a surface-activated titanium oxide product and of using same in water treatment processes discloses method of preparation of titanium dioxide with new structure. This patent publication discloses a new nanocrystalline titanium oxide for treatment of dissolved contaminants from water. The physical evidence given in this patent application confirms that this new nanocrystalline titanium oxide material is different from any previously disclosed titanium compounds.

One of latest publications is work by M. Bissen and others titled TiO₂-catalazed photooxydation of arsenite to arsenate in aqueous samples, Chemosphere 44 (2001) 751-757. reports oxidation of As(III) into As(V) and adsorption of As(III) and As(V) on the surface of P-25™ titanium dioxide from Degussa, included herein as reference. Importantly, quantity of adsorbed arsenic on the titanium dioxide is in good agreement with our results obtained for P-25™ and is many times less than reported in our invention. Materials and methods that we disclose in present invention are different from P-25™ and are at least ten times better adsorbents for As(V) and As(III) than P-_{25™.}

Following discussion is very important for understanding of present invention and its objectives and how it is innovatively different from what was known in prior art. It is extremely important to say that the titanium dioxides anatase, brookite and rutile having a same chemical formula TiO₂ have no hydroxyl groups, which could be used for adsorption process through surface reaction with ions and compounds dissolved in water. It is also very important to state here that anatase, brookite and rutile titanium dioxides are highly stable compounds and do not react with other compounds under conditions close to ambient. It is also especially important for understanding of current invention to state that crystalline titanium dioxides of anatase, brookite, and rutile structures do not react with dissolved in water contaminants, and, even more, they do not react even with strong acids and bases.

Now, it is necessary to describe briefly existing titanium dioxide industry and important patents related to production and use of titanium dioxides. Titanium dioxide pigment industry is a very large sector of US and world economy and it started its existence in the beginning of the 20th century. Between 1910 and 1915, the first patents were issued for making titanium dioxide, and shortly after that two companies were formed to manufacture the pigment, one in Norway and one in the United States. 1916 was the year in which the Titanium Pigment Corporation of Niagara Falls, N.Y., and the Titan Co. AS, of Norway simultaneously began commercial production of this new white pigment that was principally used in paints. By the late 1920s, several additional producers entered the market, and production reached the modest level of 44 million pounds (20,000 metric tons). Today, there are more than 25 companies in 20 countries producing 8.8 billion pounds (4 million metric tons) of titanium dioxide per year. Titanium dioxide is manufactured in two crystal forms: anatase and rutile. Titanium dioxide is a white pigment widely used in the paint, paper and plastic industries. Titanium dioxide is obtained primarily from slag by two different processes: sulfate and chloride. The slag is treated with sulfuric acid, and later, the resultant titanyl sulfate is hydrolyzed to form anatase hydrate that is calcined at 1000° C. to form rutile titanium dioxide. Both the sulfate and the chloride process produce rutile crystalline forms, but only the sulfate process produces anatase titanium dioxide, the form that is preferred for food, drug and cosmetic use. Both processes are described in some detail in Kirk-Othmer's Encyclopedia of Chemical Technology, 3rd Edition, Vol. 23 at pp. 143-148. Although the sulfate process used to be dominant source of titanium pigment in past, the chloride process is growing more rapidly because it is more energy efficient and more environmentally friendly. However, the feedstock requirements for the chloride process are more demanding, generally requiring rutile-grade material for operation.

In accordance with the methods of present invention the synthesis of quantum size effect enhanced titanium dioxide products is achieved by means that provide a favorable crystallite sizes for anatase, brookite and rutile. While this processes somewhat remind of the existing titanium dioxide production in pigment industry, they are essentially different from prior art preparation methods and processes and as well as from control methods. To understand these differences we will briefly describe how titanium dioxide pigments are made. Original production of anatase was primarily based on the process set back in 1920 by G. Jensen (U.S. Pat. No. 1,333,819). Since then many improvements have been made, however, it has not been a goal to achieve consistent production of anatase titanium dioxide with crystallite sizes below 100 Å. In fact, many samples obtained from various sulfate process of titanium dioxide production were tested and showed wide variability, not just for different producers, but also from one batch to another. Many manufacturers are taking action and it is now a common practice to reduce surface activity of anatase crystals by coating them with various oxides, such as alumina, silica and others inorganic materials. Thus manufactured anatase grade titanium dioxides are perfectly suitable for designated applications in paper, cosmetic and other industries. Other sulfate process titanium dioxide producers use obtained anatase for converting it into rutile by high temperature calcinations. The sizes and size distribution of these anatase crystals are mostly not suitable for purpose of current invention; however, some batches may partially become suitable.

The rutile titanium dioxide produced by calcinations of anatase of sulfate process or by thermal hydrolysis of titanium tetrachloride of chloride process. Because of their preparation methods they normally have very large crystals, often larger than several hundred nanometers. Thus, rutile produced by pigment industry is not suitable for water treatment application. For example, Kemira Oy offers so called FINNTi™ series of fine rutile products with approximately 1-3 micron crystal sizes, organic coated, UV-TITAN P-160™ particle size of 17 nanometers, and silica or alumina coated M-262™ with particle size of about 20 nanometers. Because of the particle size and coatings these materials are not suitable to achieve the goals of present invention.

However, very recently some attempts have been made to produce rutile by low temperature processes. Titanium dioxide is normally obtained in very low yields by these methods and mostly as mixtures of anatase and rutile. H. Yin and others reported (Chemistry of Materials 2002, 12, 378-383) synthesis of rod-like rutile 17×33 nanometers by hydrothermal treatment of embryos prepared by room temperature peptization of the titanium tetrachloride. M. Gopal and others (Journal of Materials Science, 1997, 32, 6001-6008) have synthesized rutile by hydrolysis of titanium alkoxides in the acidic solution, however, rutile was found to be crystallized as a mixture with anatase. A similar, largely unsuccessful attempt has been made by Z. Tang and others (Materials Chemistry and Physics 2002, 77, 314-317). U.S. Pat. No 6,001,326 describes low temperature synthesis of rutile type, often crystallized as a mixture with anatase by thermal decomposition of titanyl chloride solutions. Publication WO 03/068682 discloses production of nanocrystalline rutile in a batch process in presence of tin salts for application as a photocatalysts. U.S. Pat. No. 6,001,326 to Kim and others and U.S. patent Publication No. 6,517,804 B1 to Kim and others describe preparation of crystalline rutile and anatase mixture in a batch process by thermal and hydrothermal precipitation using titanium oxychloride solution. The crystallite size was reported to be about 10 nm, however, the method of measurement of crystallites sizes was not specified. In comparative example we have repeated the description given in this patent, prepared the samples and measured the crystallite sizes. The results indicate that the described and claimed so-called mono-dispersed ultrafine titanium dioxide have large distributions with average crystallite size well above 15 nm. These methods are batch processes and are not suitable to achieve goals of present invention.

M. Kiyama and others (Chem. Letters, 1972, 21) reported synthesis of brookite crystals of 15 nm by reaction of TiCl₃ with air. B. Ohtani and others in similar batch process synthesized brookite crystals similar and of larger sizes (Chemical Physics Letters, 1985, 120, No.3, 292-294). A. Pottier (Journal of Materials Chemistry, 2001, 11, 1116-1121) and others reported synthesis of brookite sols with crystallites about 80 nm from highly acidic solutions by thermolysis of titanium tetrachloride in a batch process.

U.S. Pat. No. 6,300,559 B1 to Ohmori discloses a dye-sensitization-type photoelectric conversion element comprising a semiconductor and a dye adhering onto a surface of the semiconductor, which semiconductor comprised of brookite-type titanium dioxide, and made using a sol predominately comprising brookite. The brookite sols have been made in a batch process by hydrolysis of titanium tetrachloride. Transmission electron microscopy studies of vacuum dried powder showed an average primary particle diameter of 50 nm. The particle size of brookite is 15 nm. U.S. Pat. No. 6,340,711 B1 to Ohmori discloses a brookite-type titanium dioxide coating made by using titanium dioxide brookite-type sol, where an average particle size of titanium dioxide particles in a sol is in range of 10 to 100 nm. U.S. Pat. No. 6,414,213 B2 to Ohmori discloses brookite coated interior member or indoor equipment and its use as a photocatalytic device. The size of brookite crystals is ranging from 5 nm to 100 nm. These three patents disclose preparation of brookite sols or powders in a batch process and its use as a coating material or as a photocatalyst.

Both anatase and rutile TiO₂ produce high opacity due to their high refractive index in comparison with extenders, fillers and early pigments. However, although anatase TiO₂ was the first to be produced commercially, and represented a step-change in optical performance over the pigments that preceded it, the rutile form of TiO₂ offers still higher opacity and durability. Although both are ‘white’ pigments, they exhibit differences in tone with anatase pigments producing a bluer tone than rutile pigments. The reason for this can be found in their somewhat different reflectance curves across the visible and near visible spectrum. Thus, rutile TiO₂ reflects radiation slightly better than anatase in all but the very blue end of the visible spectrum and in the ultra-violet region and is therefore slightly brighter. But because anatase TiO₂ absorbs less light at the blue end of the spectrum, it has a visibly bluer tone than rutile pigment. It should be noted that the mass tone of either anatase or rutile pigments are also influenced by their purity with coloring ion impurities such as iron, niobium, vanadium and chromium having a significant effect on the color of a pigment. Because the rutile form absorbs more UV radiation, it further reduces the amount of energy available to degrade the binder system and provides relatively better durability to a system than anatase. However, the durability of rutile TiO₂ pigment may be significantly improved by the addition of surface treatment. Although the difference in refractive index gives rutile pigments up to 15% opacity benefit over anatase pigments, the bluer tone and lower hardness of anatase pigments are beneficial in some applications, especially where low abrasivity may be an issue. Thus anatase pigments were originally the preferred choice for paper filling and coating and also for delustering of synthetic fibers, where the color of the application may degrade by abrasion of metal during frequent rubbing contact with machinery during processing. Where the highest possible optical efficiency and durability are required, rutile pigments are superior. In practice, virtually all paints and plastic applications are now pigmented with surface treated rutile pigments, with the coating specifically designed to maximize the performance properties required. Specially treated rutile pigments are also used in paper laminate applications where high opacity and good light stability are essential. Normally, titanium dioxide produced for pigment application is coated with alumina, silica, zirconia and also with polyol or other polymers. These coatings are designed to enhance wetting, dispersion, improve durability, entrap air etc. ‘Pure’ TiO₂ base pigments, whether anatase or rutile, provide high opacity and excellent color but have a relatively reactive surface. The majority of commercial pigments are therefore coated with an inorganic treatment or coating, and often an organic treatment. Nearly all commercial TiO₂ pigments have a surface treatment or coating to: improve wetting and dispersion in different media (water, solvent or polymer); improve compatibility with the binder and dispersion stability; improve color stability; improve durability; increase air in the film in flat latex paints. Commercial anatase and rutile, produced by industry in large quantities as pigments are mostly not suitable for effective water treatment.

Wastewater and natural waters may contain a variety of dissolved inorganic substances from natural and anthropogenic sources. Regulatory limits have been set for a number of these substances in drinking water and for discharges to natural waters, for protection of public health and of environmental quality. The regulatory limits for many of these substances are set at very low levels, e.g., in the range of 2-50 parts-per-billion (“ppb”) or the equivalent units of measure of micrograms-per-liter (“μg/L”).

Conventional water treatment processes, such as co-precipitation with iron or aluminum salts, lime softening, or filtration using adsorbents or ion exchange resins, are ineffective in removing some of these regulated substances to the mandated levels. This problem is of particular concern with respect to certain types of substances including oxyanions, particularly arsenate and arsenite, and some metals, such as mercury, because of their chemistry in water and the particularly low regulatory limits that have been set for them. Typically, the removal of such contaminants can be improved by selecting a treatment matrix (e.g., a co-precipitant or adsorbent) that exhibits a greater capacity to sequester or retain the dissolved substance of concern, or provides more favorable kinetics toward that substance (i.e., the treatment reaction proceeds more quickly). The low capacity or unfavorable kinetics of a treatment matrix can be accommodated to some extent by construction of larger treatment systems to allow the use of larger quantities of the treatment matrix or to provide longer contact times between the treatment matrix and the aqueous stream undergoing treatment. The cost of building and operating such a system increase with the size of the system and often causes such an accommodation to become uneconomical.

There are many operational and economic disadvantages associated with known water purification systems. The present invention maximizes the purification of water without introducing the disadvantages of current systems. Furthermore the water purification is performed using novel materials and methods described in present invention possess certain advantageous qualities not heretofore known or understood. Present invention has been made in these circumstances, in result of our extensive theoretical and experimental investigations.

Currently widely used medical radionuclides ^{99m}Tc and ¹⁸⁸Re are produced by from chromatographic radionuclide generators ⁹⁹Mo/^{99m}Tc and ¹⁸⁸W/¹⁸⁸Re based on alumina filled columns. Due to the low adsorption capacity and partial solubility of alumina in elution solutions very large alumina columns used and the eluted solutions are not free from parent long-lived isotopes. As we will show below the due to the exceptionally high adsorption capacity of adsorbents of the present invention toward W and Mo and very low solubility of titanium dioxide in the elution solutions it is possible to prepare highly efficient radionuclide generators for the production of carrier free diagnostic and therapeutic ^{99m}Tc and ¹⁸⁸Re nuclides.

The present inventors have thought that all three types of titanium dioxides, namely anatase, brookite and rutile are large band gap semiconductors and will have special and somewhat similar surface properties, arising from quantum size effects if the sizes of crystallites are reduced to approximately 100 Å with such properties being observed in aqueous solutions. It is known that rutile titanium dioxide crystal has a band gap of 3.0 eV, anatase titanium dioxide has a band gap of 3.2 eV and brookite titanium dioxide has a band gap of more than 3.25 eV. It is also well known that all these three titanium dioxide crystals because of their band gap energy position and location of valence and conductivity band energies in relation to the normal hydrogen electrode (SHE) intensely adsorb only ultraviolet part of the solar emission and, conversely, adsorb very weekly the rays in visible range. The present inventors have thought that even the amounts of ultraviolet rays in the solar emission reaching the earth surface is not substantial, however when the sizes of crystals are reduced below approximately 100 Å they will generate plethora of surface hydroxyl groups. This hypothesis of present inventors is based on observation that the electronic band structure of a semiconductor oxide is size-dependent when its dimensions are comparable with the exciton (Bohr) radius. More specifically, when the sizes of titanium dioxide semiconductors are small the band gap will be increased due to quantum size effects. This band gap increase could be for example 0.15 eV or bigger for anatase (3.2 eV) if the sizes of crystallites are about 30-40Å. Similar, increase of band gap will also occur for rutile (3.0 eV) and brookite (>3.25 eV). If this hypothesis holds, then even under normal solar emission conditions with limited amounts of ultraviolet rays titanium dioxide surface will be activated via the excitation of electrons from the valence band and will transfer them across the band gap into the conduction band. The positively charged ‘hole’ states remaining in the valence band will appear at the surface of titanium dioxide. Reaction of these ‘holes’ with water will generate plethora of powerful hydroxyl groups. The positively charged ‘hole’ states will also act as extremely powerful oxidizing agents. This process for example will able to oxidize As(III) to As(V) very quickly.

Present inventors conceived the idea that these quantum size effects on titanium dioxide surfaces could be used for the removal of contaminant ions dissolved in water. Simultaneous indiscriminant oxidation properties as well as generation of surface hydroxyl groups will be extremely reactive towards contaminant ions.

Present inventors have performed numerous experiments to reduce to practice the hypothesis and validate it for the removal of various contaminants from water. For this purposes they have performed numerous experiments to prepare anatase, brookite and rutile crystals of different sizes, determine the crystallite sizes and their distribution and investigated the dependence of generation of surface hydroxyl groups, oxidation of ions and molecules, as well as use of these surface phenomenon for the removal of different contaminants from water. We have obtained for the first time astonishing results, never attended in prior art.

Inventors also have conceived an idea that the photochemical properties of these minute crystals will be different than those of large crystals. Of great importance is the fact that a depletion layer cannot be formed in the crystals since the crystals are too small. The voltage drop within such small crystals is as small as few millivolts under reverse bias. As result there is no significant local electric field to provide separation of photogenerated electron-hole pairs. The photoresponse of the crystallite body is determined by the rate of reaction of the positive and negative charge carriers with the redox couple present in the electrolyte. If the transfer of electrons to the electrolyte is faster than that of holes, then a cathodic photocurrent will flow, like in a p-type semiconductor/liquid junction. In contrast if hole transfer to the electrolyte is faster, then anodic photocurrent will flow, as in n-type semiconductor in formed photoelectrochemical cells. These means that titanium dioxide crystals could show alternatively n- or p-type behavior, depending on the nature of the hole or electron scavenger present in the electrolyte liquid. These are further means that we can expect to utilize for adsorbance of cationic and anionic spices from water systems. The molecular mechanism of removal for cations, anions, molecular species, and competitive adsorption of mixture contaminants will be varied accordingly.

Present invention has been made under these circumstances and a primary object of the invention is to provide a new adsorbents with plethora of surface hydroxyl groups on small crystallites of anatase, brookite and rutile, develop new continuous process for production of these titanium dioxides with controlled size crystals and use these crystals as effective adsorbents for the removal of contaminant molecules and ions from water. Purpose of detailed invention description including examples, below is to show: First, commercially available titanium dioxides are largely not suitable as their crystallite size and other characteristics vary in uncontrollable manner; Second, surface specific properties of anatase, brookite and rutile products only become suitable for successful water treatment, when they are prepared according to the methods of present invention; Third, the quantum size effected hydroxylation of surfaces of crystalline titanium dioxides and use of this effect in water treatment has never been anticipated in prior art; Forth, crystallite size and its particular distribution for anatase, brookite and rutile and as result of that phenomenal rapid adsorption of water contaminations have never been attended in prior art.

Use of crystalline titanium dioxides with anatase, brookite and rutile structures as adsorbents of water contaminants are not suggested by the references.

Now, with the use of the materials, methods and processes accomplished according to the present invention it is possible to treat the water systems and remove various contaminants in quantities and rates than heretofore been considered as theoretically and practically possible.

### OBJECTS OF THE INVENTION

One object of the present invention is to provide highly effective inorganic adsorbents for water treatment processes, comprising of surface hydroxylated crystalline titanium dioxides with structures selected from the group of anatase, brookite and rutile.

Another object of the present invention is to provide the preparation methods of titanium dioxides of anatase, brookite and rutile structures, and mixtures of them with crystallite sizes essentially below 100 Å.

Another object of the present invention is to provide application of titanium dioxide based adsorbents for the removal of contaminants from water systems.

Another object of the present invention is to provide methods of in situ fixation of contaminants in water, soil systems.

Another object of the present invention is to provide highly effective inorganic adsorbents for removal, isolation and separation of phosphorylated peptides from unphosphorylated peptides, comprising of surface hydroxylated crystalline titanium dioxides with structures selected from the group of anatase, brookite and rutile.

Another object of the present invention is to provide a chromatographic media for isolation, separation, enrichment of various proteins, isotopes, molecules and ions, comprising of surface hydroxylated crystalline titanium dioxides with structures selected from the group of anatase, brookite and rutile.

Another object of the present invention is to provide a adsorptive media for the production of carrier-free radionuclides diagnostic and therapeutic ^{99m}Tc and ¹⁸⁸Re via radionuclide generator schemes: ⁹⁹Mo/^{99m}Tc and ¹⁸⁸W/¹⁸⁸Re.

Other objects of the present invention will become more apparent to those of ordinary skill in the art in light of the following discussion and illustrative examples.

### SUMMARY OF THE INVENTION

These and other objects of the present invention are summarized as follows. The present invention is adsorbent materials, methods of making and methods of using said adsorbents for the removal or concentration or retention and recovery of harmful or valuable dissolved ions and compounds from aqueous systems by exploiting of quantum size effect phenomenon on small titanium dioxide large band gap semiconductors. The size and size distribution of crystals is a critical parameter to practice the advantages of present invention. What provided by present invention and what was not known in prior art is the astonishing adsorption of dissolved ions and compounds on surface of titanium dioxide which occurs only if the sizes of crystals are essentially below about 200 Å, preferable below 100 Å. And importantly, adsorption effects are practically absent on large crystals, so that the invention effect is non-monotonous, but instead is a property of very small crystals.

Main and determinative aspect of the present invention is based on our surprising discovery that all three titanium dioxides having water-free and hydrogen-free formula TiO₂, namely, anatase, brookite and rutile, normally inactive towards other compounds, even towards most acids and bases, become astonishingly reactive for surface reactions when the sizes of crystals are essentially below about 200 Å, preferable below 100 Å.

A first aspect the present invention comprises a method of generation of surface hydroxyl groups on the surface of anatase, brookite and rutile large band gap semiconductors by reducing dimensions of individual crystals to the sizes where surface hydroxyl groups are self generated via quantum size effects when they are in contact with electrolytes. In this major embodiment of current invention it has been theoretically deducted and reduced to practice that nanocrystalline semiconductors titanium dioxides of anatase, brookite and rutile structures will self generate a plethora of surface hydroxyl groups when the sizes of crystals are in a certain range. A preferred embodiment of the method is a nanocrystalline anatase, nanocrystalline brookite and nanocrystalline rutile i.e., titanium dioxides having anatase, brookite and rutile crystals with primary crystallite diameters within the range of about 1 nm to about 20 nm; preferably, within the range of about 1 nm to about 10 nm or up to approximately 10 unit cell sizes.

A second aspect of the present invention comprises methods of preparation of nanocrystalline titanium dioxide products of anatase, brookite and rutile structures or mixtures of them with crystallite sizes within the range of about 10 Å to about 200 Å; preferably, within the range of about 10 Å to about 100 Å or up to approximately 10 unit cell sizes. A preferred embodiment of the production methods includes the various steps of preparing titanium dioxides of anatase, brookite and rutile structures and mixtures of them in any proportion using various titanium compounds by facile processes at temperatures up to 150° C., preferably up to 110° C. The methods of preparation of individual crystalline forms, mixtures, preparation on support materials vary accordingly to achieve conditions where the quantity and accessibility of nanocrystals are maximized and crystallite growth above 300 Å is minimized. Characteristic and important feature of all methods of preparing quantum size effect enabled anatase, brookite and rutile of present invention is that the process of nucleation and duration of crystallization is affected by various means and aborted to prevent growth of crystals above certain sizes.

A third aspect of the present invention comprises a method for removing dissolved ions and compounds from a dilute aqueous solutions, which includes the step of contacting a quantum size effect surface hydroxylated nanocrystalline titanium oxide product with such aqueous solutions. Such dissolved inorganic contaminants include but not limited to arsenite, arsenate, cadmium, chromium, copper, lead, mercury, tungsten, uranium, and zinc, and low-molecular weight organic arsenic compounds, such as monomethylarsonic acid, dimethylarsinic acid, or phenylarsonic acid. The nanocrystalline titanium dioxide product for adsorption application, preferably comprising a nano crystalline anatase, a nanocrystal line brookite, a nanocrystal line rutile or mixtures thereof may be in a powdered form, in a granular form comprising one or more binders and support materials, in the form of a coating on a support materials, or in other forms that will be obvious to those having ordinary skill in the relevant arts. In a preferred embodiment of the method, the nanocrystalline titanium oxide product is suspended as a sol in the aqueous stream to provide the necessary contact. In another preferred embodiment, the dilute aqueous stream is filtered through a bed of nanocrystalline titanium oxide product; such bed being in a vessel (e.g., a packed column) or in the ground for treatment of groundwater or surface water.

A forth aspect of the invention comprises a method for preventing the dissolution or migration of inorganic contaminants in groundwater by injecting a sol of a nanocrystalline titanium dioxide into an aquifer to bind contaminants to the titanium dioxide product therein.

A fifth aspect of the present invention comprises the methods for isolation, separation, enrichment of various molecules, ions, proteins, peptides and other species of various origin using of the adsorbents of present invention using column, batch and other conditions.

A sixth aspect of the present invention comprises the methods of carrier-free radionuclide production by radionuclide generator scheme.

The adsorbent materials, methods, specifications of use are described in detail below.

### BRIEF DESCRIPTION OF THE FIGURES

For a more complete understanding of the present invention, reference is made to the following detailed description of the present invention considered in conjunction with the accompanying drawings and these drawings are for the purpose of illustration only and not to be taken as limitations on the invention, in which:

FIG. 1 is a schematic drawing of large (top) and small (bottom) anatase crystals, where the black and white squares and rectangles are two dimensional unit cells. Large anatase crystal is composed of 106×39×39=160,000 unit cells and has approximately (150×150×1000) Å dimensions. Small anatase crystal is composed of 7×7×7=343 unit cells and has approximately (26×26×67) Å dimensions. According embodiments and claims of present invention the small crystals when contacted with electrolyte solutions and vapors, water for example, will generate plethora of surface hydroxyl groups due to the quantum size effects in semiconductors, highly reactive towards adsorption reactions with contaminant molecules and ions. The sizes of small crystals are not known exactly; however, these quantum size effects leading to self-generation of reactive surface hydroxyl groups in ample quantities are particularly enhanced when sizes of crystals are below approximately 100 Å, or below approximately 10-20 unit cell sizes. The large crystals do not generate surface hydroxyl groups or surface groups or generate them only in very small quantities.

FIG. 2 is a schematic drawing of anatase crystals structure cross-section, where vertical direction is [001], horizontal direction is [010] and [100] direction is perpendicular to plane of paper. Positive [001] direction is representing the surface of crystal. According to present invention most of oxygen atoms coordinating surface titanium atoms will be hydroxylated upon contact with electrolytes.

FIG. 3 is a cross-sectional drawing of structure of anatase with terminal [001] direction. The shortest terminal oxygen-oxygen distances are 3.78 Å. Defect-free surface of XY plane will have approximately one hydroxyl group for every 14.2 Å². However, the surface hydroxyl will be formed only on the surfaces of small crystals; the large micron sized crystals do not have such hydroxyl groups on defect-free surfaces. Theoretical density of the hydroxyl groups is about seven OH groups per nm².

FIG. 4 is a block flow diagram of processes for producing titanium oxides of anatase, brookite and rutile structures, according to the present invention, by controlled and continuous thermal hydrolysis.

FIG. 5 is the X-ray powder diffraction patterns of nanocrystalline anatase with various diameters of primary crystals as determined from peak broadening using Scherrer equation.

FIG. 6 is the X-ray powder diffraction patterns of nanocrystalline brookite with various diameters of primary crystals as determined from peak broadening using Scherrer equation.

FIG. 7 is the X-ray powder diffraction patterns of nanocrystalline rutile with various diameters of primary crystals as determined from peak broadening using Scherrer equation.

FIG. 8 is a Warren-Averbach crystallite size distribution for nanocrystalline anatase, showing that the sizes of 96.5 percent of crystals comprising sample do not exceed 100 Å. The average volume weighted crystallite size is 38 angstrom.

FIG. 9 is a Warren-Averbach crystallite size distribution for nanocrystalline anatase, showing that the sizes of 90 percent of crystals comprising sample do not exceed 100 Å. The average volume weighted crystallite size is 54 angstrom.

FIG. 10 is a Warren-Averbach crystallite size distribution for nanocrystalline anatase, showing that the sizes of 66 percent of crystals comprising sample do not exceed 100 Å. The average volume weighted crystallite size is 85 angstrom.

FIG. 11 is a Warren-Averbach crystallite size distribution for nanocrystalline anatase, showing that the sizes of 26 percent of crystals comprising sample do not exceed 100 Å. The average volume weighted crystallite size is 158 angstrom.

FIG. 12 is a Warren-Averbach crystallite size distribution for commercial titanium dioxide P-₂₅™ from Degussa, showing that the sizes of 12.8 percent of anatase crystals and 1.58 percent of rutile crystals comprising sample do not exceed 100 Å. The average volume weighted crystallite sizes are 210 for anatase and 329 angstrom for rutile. The sample consists of 75.7 weight % of anatase and 24.3 weight % of rutile.

FIG. 13 is a Warren-Averbach crystallite size distribution for nanocrystalline brookite, showing that the sizes of 96.4 percent of crystals comprising sample do not exceed 100 Å. The average volume weighted crystallite size is 35 angstrom.

FIG. 14 is a Warren-Averbach crystallite size distribution for nanocrystalline brookite, showing that the sizes of 42 percent of crystals comprising sample do not exceed 100 Å. The average volume weighted crystallite size is 133 angstrom.

FIG. 15 is a Warren-Averbach crystallite size distribution for nanocrystalline brookite, showing that the sizes of less than one percent of crystals comprising sample do not exceed 100 Å. The average volume weighted crystallite size is 854 angstrom.

FIG. 16 is a Warren-Averbach crystallite size distribution for nanocrystalline rutile, showing that the sizes of 73.1 percent of crystals comprising sample do not exceed 100 Å. The average volume weighted crystallite size is 75 angstrom.

FIG. 17 is a Warren-Averbach crystallite size distribution for nanocrystalline rutile, showing that the sizes of 58.2 percent of crystals comprising sample do not exceed 100 Å. The average volume weighted crystallite size is 102 angstrom.

FIG. 18 is a Warren-Averbach crystallite size distribution for nanocrystalline rutile, showing that the sizes of 7.7 percent of crystals comprising sample do not exceed 100 Å. The average volume weighted crystallite size is 286 angstrom.

FIG. 19 is a Warren-Averbach crystallite size distribution for nanocrystalline rutile, showing that the sizes of less than one percent of crystals comprising sample do not exceed 100 Å. The average volume weighted crystallite size is 774 angstrom.

FIG. 20 is a X-ray powder diffraction patterns of nanocrystalline titanium dioxide mixtures: top—37.5% brookite with crystallite sizes of 66.4 angstrom by integral breadth method and 62.5% rutile with crystallite sizes of 79.4 angstrom by integral breadth method; bottom—9.1% anatase with crystallite sizes of 65.8 angstrom by integral breadth method and 90.9% rutile with crystallite sizes by integral breadth method of 80.0 angstrom. Concentrations of components are determined by Rietveld quantification method.

FIG. 21 is a X-ray powder diffraction patterns of nanocrystalline titanium dioxide mixtures: top—16.1% anatase with crystallite sizes by integral breadth method of 53.4 angstrom, 60.1% brookite with crystallite sizes by integral breadth method of 71.3 angstrom and 23.7% rutile with crystallite sizes by integral breadth method of 11.75 angstrom; bottom—58.2% anatase with crystallite sizes by integral breadth method of 40.6 angstrom and 41.8% rutile with crystallite sizes by integral breadth method of 83.90 angstrom. Concentrations of components are determined by Rietveld quantification method.

FIG. 22 is graphical representation of the efficiencies of various titanium dioxides samples with anatase crystal structure in removing dissolved arsenate and arsenite from water. Increased generation of surface hydroxyl group according to method of present invention leads to increased arsenate adsorption and increased arsenite oxidation of As(III) to As(V).

FIG. 23 is graphical representation of the efficiencies of various titanium dioxides samples with brookite crystal structure in removing dissolved arsenate and arsenite from water. Increased generation of surface hydroxyl group according method of present invention leads to increased arsenate adsorption and increased arsenite oxidation of As(III) to As(V).

FIG. 24 is graphical representation of the efficiencies of various titanium dioxides samples with rutile crystal structure in removing dissolved arsenate and arsenite from water. Increased generation of surface hydroxyl group according method of present invention leads to increased arsenate adsorption and increased arsenite oxidation of As(III) to As(V).

FIG. 25 is graphical representation of the efficiencies of mixtures of titanium dioxides samples with various crystal structures in removing dissolved arsenate from water.

FIG. 26 is a graph showing the changes in influent and effluent concentrations of arsenic over the number of bed volumes of an spiked with As(V) tap water filtered through a packed column of anatase prepared according to the present invention.

FIG. 27a is a schematic diagram of a packed column for filtration process implemented according to the present invention.

FIG. 27b is a schematic diagram of an in-ground injection system implemented according to the present invention to filter contaminants from groundwater and/or fix contaminants in soil.

FIG. 27c is a schematic diagram of in situ large volume water treatment system implemented according to the present invention.

FIG. 27d is a schematic drawing of a titanium dioxide coated drinking plastic or paper cup implemented according to the present invention.

FIG. 27e is a schematic drawing of a batch treatment of water achieved by immersing titanium dioxide solid or powdered forms in a container with contaminated water.

### DETAILED DESCRIPTION OF THE INVENTION

The present invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Foregoing detailed description has been given for clearness of understanding and no undue limitation should be deduced therefrom, but the appended claims should be construed as broadly as permissible in view of the prior art.

Present invention is describing the chemical compounds, their structural aspects, processes, methods, properties, testing of said compounds, more particularly solid state compounds of titanium dioxides: anatase, brookite and rutile. First we would like to define anatase, brookite and rutile in terms of composition and structure. Anatase, brookite and rutile compositions, structures and materials as they are described here should be understood by skilled in art as if they correspond to descriptions given below.

Anatase titanium dioxide of present invention is defined to be a structural analog of a compound as it is described in ICSD (Inorganic Crystal Structure Database, Fachinformationszentrum Karlsruhe, Germany (FIZ) and The National Institute of Standards and Technology, Gaithersburg, Md. USA (NIST), version 1.3.1, 2003) ICSD No 63711, based on work of Howard, C. J.; Sabine, T. M.; Dickson, F. Structural and Thermal Parameters for Rutile and Anatase Acta Crystallographica B 47, 462-468(1991). It crystallizes in tetragonal Space Group 14₁/amd (No 141) with unit cell parameters a=3.7845 Å, b=3.7845 Å, c=9.5143 Å and alpha=90, beta=90, gamma=90 degrees. Anatase titanium dioxide samples of present invention show a X-ray powder diffraction pattern obtained employing a well aligned powder Bragg-Brentano geometry diffractometer, with calibrated zero shift and other standards, such as internal standard and when it is free from preferred orientation, that agrees with that of given in PDF No 21-1272 in PDF-2 database published by ICDD (The International Centre for Diffraction Data) Newtown Square, Pa., USA. The structural arrangement of titanium and oxygen atoms, partial isomorphic substitution of titanium and/or oxygen atoms, vacancies, sample synthesis methods, preferred orientation, crystallinity, crystal size and others for the particular sample could affect the diffraction pattern, such as unit cell parameters, diffraction peak positions and intensities. Importantly, these minor but common effects are easily detectable by qualified crystallographer. All such changes may affect certain physical and chemical properties of samples, for example band gap energy and band gap energy for valence and conductivity levels for anatase semiconductor. However, such property modifications are also an object of present invention as far as structure is considered to be isostructural to anatase as it is defined above. Physical evidence for anatase titanium dioxide of present invention could be an X-ray powder diffraction method that will show a powder diffraction pattern, when applied correctly, with Bragg diffraction peaks as those described in PDF No 21-1272 and simultaneously, the chemical analysis that will show presence of titanium and oxygen in molar ratio essentially not deviating from Ti:O=1:2. However, some titanium atoms could be substituted with other atoms, such as Zr, Nb, Sn, Ge, Si, Al and others.

Brookite titanium dioxide of present invention is defined to be a structural analog of a compound as it is described in ICSD (Inorganic Crystal Structure Database, Fachinformationszentrum Karlsruhe, Germany (FIZ) and The National Institute of Standards and Technology, Gaithersburg, Md. USA (NIST), version 1.3.1, 2003) ICSD No 63710, based on work of Meagher, E. P.; Lager, G. A Polyhedral thermal expansion in the Ti O2 polymorphs. Canadian Mineralogist 17, 77-85 (1979). It crystallizes in orthorhombic Space Group Pbca (No 61) with unit cell parameters a=9.174 Å, b=5.449 Å, c=5.138 Å and alpha=90, beta=90, gamma=90 degrees. Brookite titanium dioxide samples of present invention show a X-ray powder diffraction pattern obtained employing a well aligned powder Bragg-Brentano geometry diffractometer, with calibrated zero shift and other standards, such as internal standard and when it is free from preferred orientation, that agrees with that of given in PDF No 29-1360 in PDF2 database published by ICDD (The International Centre for Diffraction Data) Newtown Square, Pa., USA. The structural arrangement of titanium and oxygen atoms, partial isomorphic substitution of titanium and/or oxygen atoms, vacancies, sample synthesis methods, preferred orientation, crystallinity, crystal size and others for the particular sample could affect the diffraction pattern, such as unit cell parameters, diffraction peak positions and intensities. Importantly, these minor but common are effects easily detectable by qualified crystallographer. All such changes may affect certain physical and chemical properties of samples, for example band gap energy and band gap energy for valence and conductivity levels for brookite semiconductor. However, such property modifications are also an object of present invention as far as structure is considered to be isostructural to brookite as it is defined above. Physical evidence for brookite titanium dioxide of present invention could be an X-ray powder diffraction method that will show a powder diffraction pattern, when applied correctly, with Bragg diffraction peaks as those described in PDF No 29-1360 and simultaneously, the chemical analysis that will show presence of titanium and oxygen in molar ratio essentially not deviating from Ti:O=1:2. However, some titanium atoms could be substituted with other atoms, such as Zr, Nb, Sn, Ge, Si, Al and others.

Rutile titanium dioxide of present invention is defined to be a structural analog of a compound as it is described in ICSD (Inorganic Crystal Structure Database, Fachinformationszentrum Karlsruhe, Germany (FIZ) and The National Institute of Standards and Technology, Gaithersburg, Md. USA (NIST), version 1.3.1, 2003) ICSD No 63710, based on work of Howard, C. J.; Sabine, T. M.; Dickson, F. Structural and Thermal Parameters for Rutile and Rutile Acta Crystallographica B 47, 462-468(1991). It crystallizes in tetragonal Space Group P4₂/mnm (No 136) with unit cell parameters a=4.5937 Å, b=4.5937 Å, c=2.9587 Å and alpha=90, beta=90, gamma=90 degrees. Rutile titanium dioxide samples of present invention show a X-ray powder diffraction pattern obtained employing a well aligned powder Bragg-Brentano geometry diffractometer, with calibrated zero shift and other standards, such as internal standard and when it is free from preferred orientation, that agrees with that of given in PDF No 21-1276 in PDF2 database published by ICDD (The International Centre for Diffraction Data) Newtown Square, Pa., USA. The structural arrangement of titanium and oxygen atoms, partial isomorphic substitution of titanium and/or oxygen atoms, vacancies, sample synthesis methods, preferred orientation, crystallinity, crystal size and others for the particular sample could affect the diffraction pattern, such as unit cell parameters, diffraction peak positions and intensities. Importantly, these minor but common effects are easily detectable by qualified crystallographer. All such changes may affect certain physical and chemical properties of samples, for example band gap energy and band gap energy for valence and conductivity levels for rutile semiconductor. However, such property modifications are also an object of present invention as far as structure is considered to be isostructural to rutile as it is defined above. Physical evidence for rutile titanium dioxide of present invention could be an X-ray powder diffraction method that will show a powder diffraction pattern, when applied correctly, with Bragg diffraction peaks as those described in PDF No 21-1276 and simultaneously, the chemical analysis that will show presence of titanium and oxygen in molar ratio essentially not deviating from Ti:O=1:2. However, some titanium atoms could be substituted with other atoms, such as Zr, Nb, Sn, Ge, Si, Al and others.

The present invention comprises methods for producing surface hydroxyl groups on surfaces of crystalline titanium dioxides by production of the crystallites with sizes when the crystallite sizes and size distribution are essentially below 100 Å, so that the obtained titanium dioxide surfaces are affected by quantum size effects and able to self-generate plethora of surface hydroxyl groups. The quantum size effect should be understood as a physical and chemical phenomenon when the size of ionic and/or covalently bonded group of atoms in a certain way show non-classical behavior of individual atoms, molecules or bulk solids. The chemical formula of titanium dioxide is composed from titanium atom and two oxygen atoms. Bulk crystals of titanium dioxide of anatase, brookite and rutile structures contain large number of atoms, with the quantity of internal atoms being very large in comparison with quantity of surface atoms. When the sizes of titanium dioxide crystal become smaller, for example, few nanometers, the physical and chemical behavior of surface atoms change dramatically, because of the change in the ratio of surface atoms to the internal atoms. For example, anatase crystals having size of one unit cell (1×1×1) contain 31 atoms, 2×2×2 cells (8 cells) contain 159 atoms, 3×3×3 cells (27 cells) contain 457 atoms, 4×4×4 cells (64 cells) contain 997 atoms, 5×5×5 cells (8 cells) contain 1851 atoms and 10×10×10 cells (1000 cells) contain 13351 atoms. The ratio of surface atoms to the internal atoms in these very small crystals is much larger than that of micron sized crystal. Importantly, physical and chemical properties of surface atoms in these small crystals are dramatically different from those of large crystals. The oxygen atoms bound to the surface titanium atoms in these small crystals are being transformed into highly reactive hydroxyl groups when in contact with electrolytes. In fact, as it will be seen further the adsorption properties of these small crystals are dramatically better than those of large crystals. It is also important to say that these high adsorption capacity and rates mostly do not result from the higher surface area. We will also demonstrate that for example the adsorption properties of one large crystal versus adsorption of several small crystals of same surface area are different. In fact, the large crystal of certain size basically adsorbs very small amounts, if any, of contaminants dissolved in water. It may be further speculated that generation of surface hydroxyl groups is a result of photosplitting of water molecules by nanosized semiconductors. It may be also difficult to measure and quantify surface hydroxyl groups directly in water by Fourier Transform Infrared Spectroscopy (FTIR) because of interference of water molecules. To resolve vibration of hydroxyl groups a sample should be vacuumed to remove water, but this is not relevant and not adequate because it cannot provide an ‘in situ’ conditions.

Various embodiments of the present invention will now be described with reference to the figures in which like numbers correspond to like references throughout.

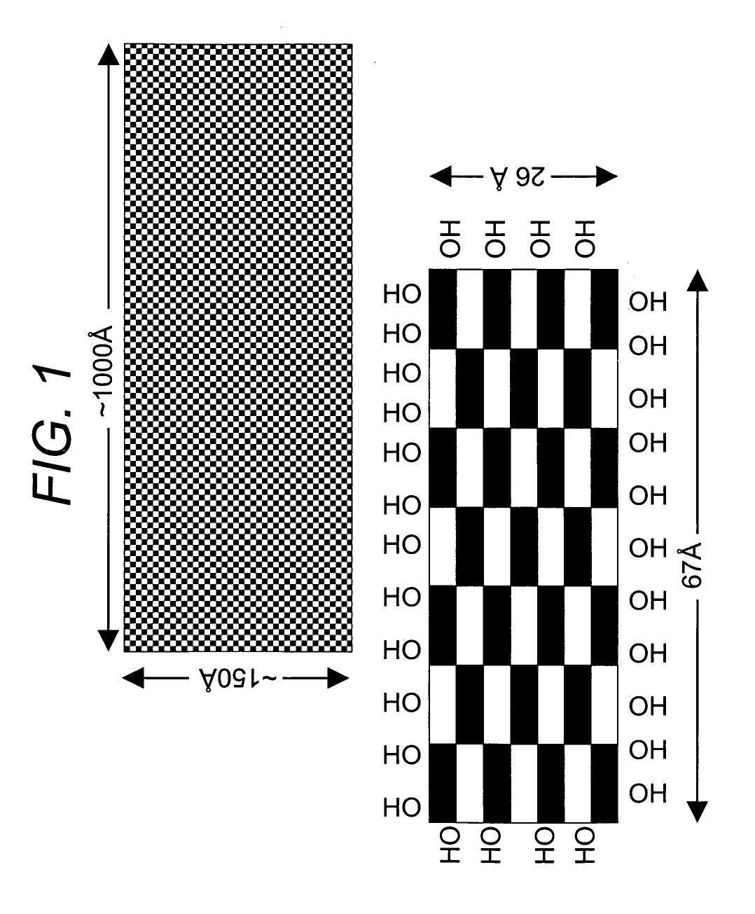

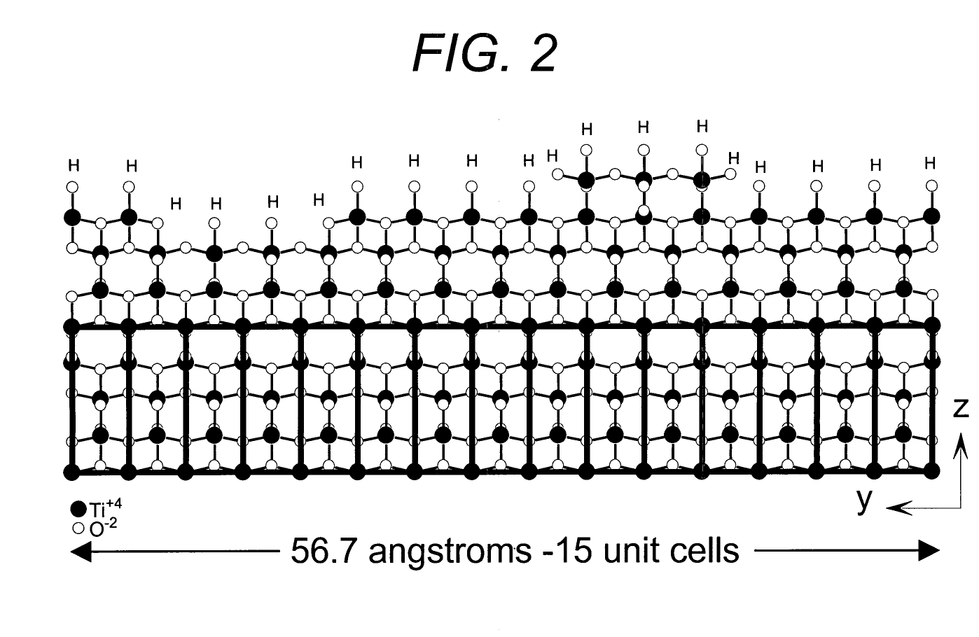

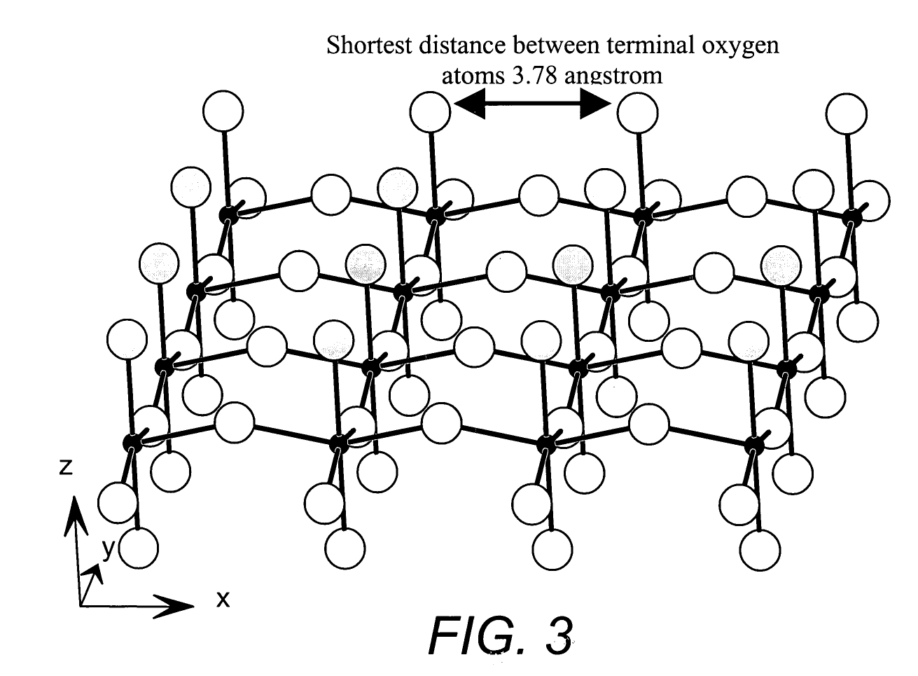

This major embodiment of present invention is illustrated in FIG. 1, FIG. 2 and FIG. 3. While the explanation and theory given appear reasonable, any and all theory and explanations of the method are disclaimed. It is needed to be said that this embodiment and related claims appended are not claiming the theoretical speculation and explanation given here, but rather a method of generation surface hydroxyl groups by reducing the size of crystals to values when properties of surface atoms dramatically change leading to the self-generation of plethora of highly reactive hydroxyl groups. As it will be shown in further description and examples, these hydroxyl groups are highly reactive towards molecules and ions of water contaminants. It is important to state that this is not obvious, moreover has never been previously attended. Furthermore, this method of creation of surface hydroxyl groups and use of this method for the removal of dissolved in water ions and compounds has very important economic and health related consequence as it is able to produce adsorbents in cost effective and predictable manner and clean up water of natural and industrial origins. Adsorbents, as it also will be shown below are very effective for the removal of many poisonous and radioactive substances such as arsenate, arsenite, chromates, uranium and transuranic elements, tungsten, molybdenum, copper, nickel, mercury, cadmium, lead, selenium and others.

Referring to FIG. 1 diagram showing large and small anatase crystals. The large crystal is comprised of 106×39×39≈160,000 unit cells and has approximately (150×150×1000) Å dimensions. Small anatase crystal is composed of 7×7×7=343 unit cells and has approximately (26×26×67) Å dimensions. The black and white squares and rectangles are two dimensional unit cells. According to the embodiments and claims of present invention the small crystals when put in contact with electrolyte solutions or vapors, water for example, will generate plethora of surface hydroxyl groups due to the quantum size effects in semiconductors, which adsorb to very high extent the molecules and ions of contaminant. The sizes of small crystals cannot be expressed using exact numbers; however these quantum size effects leading for self-generation of reactive surface hydroxyl groups in ample quantities are particularly enhanced when sizes of crystals are approximately below 100 Å or approximately below 10-20 unit cell sizes. The large crystals do not generate surface hydroxyl groups or the surface groups or generate them in very small quantities. The drawings (FIG. 1, FIG. 2 and FIG. 3) are made for anatase crystals but they are also applicable to brookite and rutile provided the cell sizes of brookite and rutile are taken into account.

Referring to FIG. 2 a schematic drawing of anatase crystals structure cross-section, where vertical direction is [001], horizontal direction is [010] and [100] direction is perpendicular to the plane of the paper. Positive [001] direction represents the surface of crystal. According to present invention most of oxygen atoms coordinating surface titanium atoms will be hydroxylated upon contact with electrolytes. The drawing is made for anatase crystals but is also applicable to brookite and rutile provided the cell sizes of brookite and rutile are taken into account.

Referring to FIG. 3 a cross-sectional drawing of anatase structure with terminal

direction. The shortest terminal oxygen-oxygen distances are 3.78 Å. Defect-free surface of XY plane will have approximately one hydroxyl group for every 14.2 Å². However, the surface hydroxyl will be formed only on the surfaces of small crystals, as the large micron sized crystals do not have such hydroxyl groups on defect-free surfaces. Theoretical density of the hydroxyl groups is about seven OH groups per nm². For example a hypothetical anatase crystal has 6.6 nm side length cubes. Volume of such crystal is 287.5 nm², surface area is 261.36 nm², mass is 1.12×10⁻¹⁸ grams. The total surface area of one gram of such crystals will have 2.33×10²⁰ nm². For monodentate adsorption of arsenate groups on the surface of titanium dioxide case one gram adsorbent should theoretically adsorb 0.2 (20 wt %) grams of As, and for bidentate case 0.1 (10 wt %)—grams of arsenic. Even in the case of five percent adsorption the bonding of arsenic to the surface of titanium dioxide should be regarded as chemosorption, because of the formation of the covalent bonds As—O—Ti. The drawing is made for anatase crystals but is also applicable to brookite and rutile provided the cell sizes of brookite and rutile are taken into account.

Present invention further comprises methods of producing quantum size effect enabled anatase, brookite and rutile. As we have described above in prior art and will describe in foregoing description and examples there are no suitable methods for large scale and reproducible production of anatase, brookite and rutile with crystallites sizes favorably distributed preferably below 100 Å. The size and size distribution of individual crystals have a critical importance for practical benefits of the present invention. As it was stated earlier currently only titanium dioxide of anatase type is available in approximately required size ranges, obtained by so called sulfate process during production of titanium dioxide pigments. However, only products from some batches are obtained in sizes suitable to practice present invention. With present invention we are introducing a new method and continuous process for production of all three types, namely anatase, brookite and rutile, with excellent control over crystallite size and crystallite size distribution. This process is new, has not been described in scientific and patent literature and provides a crucial improvement over existing methods and technologies.

Processes and Methods of Controlled Crystallites Size Anatase Preparation. The batch processes and methods to prepare titanium dioxide of anatase structure are known in prior art. It is also well known how to produce anatase titanium dioxide in form of fine crystals. As we have described in background of invention section, production of pigmentary titanium dioxide is very voluminous industry, which produces fine crystallites of anatase by a batch process through thermal hydrolysis of titanium sulfate solutions obtained from digestion of titanium rich ore, such as ilmenite. Many modifications and improvements have been developed during almost 100 years of existence of sulfate process. Currently, the titanium dioxide industry produces anatase titanium dioxide in large quantities. The quality of anatase titanium dioxide is satisfying the needs of various applications, such as food, polymer, paper, cosmetic and others. However, to achieve the goals of present invention, as it was described above we need to develop process, which has an accurate and predictable control over crystallite sizes and their favorable distribution properties. As even very small crystallites anatase about 20 nm and bigger sizes are mostly not suitable to practice our invention we need to develop a process, which in controllable and reproducible manner produces anatase in sizes up 100 Å, with crystallite size distribution that provides most if not all crystallites below 100 Å. Our studies of current anatase products samples from various suppliers showed that the anatase crystals from many producers are larger than it is needed for purposes to reduce to practice the advantages of present invention. Some samples of anatase from several producers had nearly suitable properties; however they changed unpredictably from batch to batch.

Anatase can be produced using various titanium sources. Practically all hydrolysable inorganic titanium compounds such as titanium trichloride, titanium tetrachloride, titanium sulfate, titanium iron sulfate solution, and titanium oxychloride as well as titanium alkoxides, such as titanium ethoxide, titanium butoxide, titanium isopropoxide could be used for production of anatase under certain conditions. The inorganic titanium compounds are, however, preferred as precursor compounds for large-scale production of the titanium dioxide because of cost considerations.

From economic point of view titanium sulfate solution obtained from ilmenite ore and used to for production of anatase by so-called sulfate process is probably most suitable. The process of synthesis of anatase in present invention follows previously known methods and is identical to described in prior art patent and scientific literature. However, in order to control sizes of crystals we introduce new steps and modifications. First, our process is not a batch process, but instead it is a continuous process, in which titanium sulfate solution is heated in a flow reactor. Since titanium sulfate solutions in water, sulfuric acid, iron salts may start hydrolyzing at various times depending on concentration of components, it is necessary to control and abort the hydrolysis process upon reaching crystals certain sizes. Further hydrolysis and growth of crystals is affected by relatively rapid cooling. Abortive cooling to stop crystal growth above certain sizes is a second important difference between our new method and prior art methods. Yield of titanium dioxide in this process is not as high as in processes, which seek a full hydrolysis; however the sizes of crystals are very uniform and easily could be kept below 10 Å. For titanium sulfate solutions of various compositions and hydrolysis properties the time during which the solutions is in heating zone is different and is determined experimentally. Third, important difference of present invention method is an introduction of real time control step. Suspension of samples is constantly withdrawn from heated flow reactor zone and analyzed using powder diffractometer. First few reflections of solid are scanned, and then are analyzed using Warren-Averbach method. Limited duration of heating is achieved by flow rate adjustment.

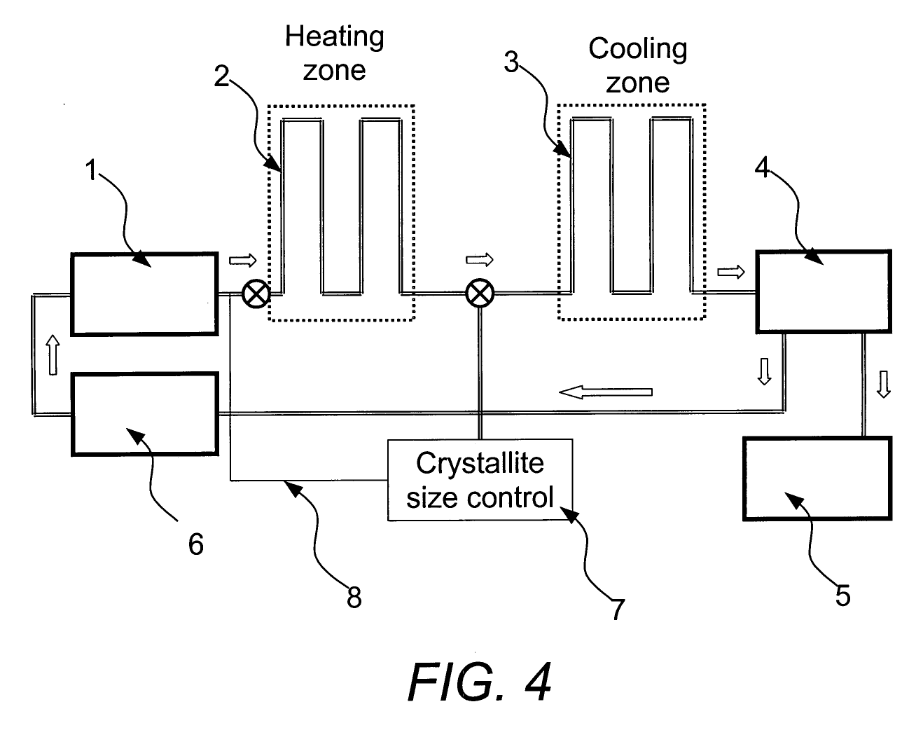

Referring to FIG. 4—titanium containing solution 1 is fed into the heating zone of the flow reactor 2 and is heated continuously. Depending on the concentration of components titanium-containing solution hydrolyzes to form titanium dioxide of certain structure. At the end of heating zone the sample is constantly taken for rapid crystallite size analysis 7. To obtain the crystallites of desired structure, crystal sizes and yields, the flow rate is adjusted 8. Upon reaching certain crystallite sizes the suspension of titanium dioxide crystallites and mother liquid is rapidly cooled in cooling zone 3 to prevent further crystallization and crystal growth above certain sizes. Then obtained titanium dioxide products are separated from mother liquid 4 and collected in 5. Titanium rich solution is collected in 6 for concentration and other parameters adjustment and transferred into the fed solution container 1. This continuous process provides means for production of anatase with desired properties.

Processes and Methods of Controlled Crystallites Size Brookite Preparation. A continuous process of the present invention for production titanium dioxide of brookite structure is based on previously disclosed batch method of Ohmori, however an important modifications and improvements have been introduced. First, our process is not a batch process, but instead a continuous process, in which yellowish and free from precipitates titanium oxychloride solution with 0.25 mol/l concentration is fed by peristaltic pump into a flow reactor which is constantly heated to 105 degrees Celsius. The tube reactor diameter and length is chosen to achieve and almost immediate heating of solution to 105° C. The pumping rate is adjusted in such a way that the time of hot solution being in a flow reactor ranges from 10 to 60 minutes. The turbid suspension containing titanium dioxide crystals at the end of heated hydrolysis reaction zone are constantly withdrawn for analysis. Further hydrolysis and growth of the crystal is affected by relatively rapid cooling. Abortive cooling to stop crystal growth above certain sizes is a second important difference between our new method and prior art methods. Yield of titanium dioxide in this process is not as high as in processes which lead to full hydrolysis, however the sizes of crystals are very uniform and could be easily kept below 100 Å. For titanium oxychloride solutions of various compositions and hydrolysis properties the times during which the solutions are in heating zone is different and determined experimentally. Third, important difference of present invention method is an introduction of a real time control step. Suspension of samples is constantly withdrawn from heated flow and analyzed using powder diffractometer. First few reflections of solid are scanned, and then are analyzed using Warren-Averbach method. Limited duration of heating is achieved by flow rate adjustment.

Referring to FIG. 4 titanium oxychloride solution 1 is fed into the ‘heating zone of flow reactor 2 and heated continuously. Depending on concentration of components titanium containing solution hydrolyzes to form titanium dioxide of certain structure. At the end of heating zone the sample is constantly taken for rapid crystallite size analysis 7. To obtain the crystallites of desired structure, crystal sizes and yields the flow rate are adjusted 8. Upon reaching certain crystallite sizes the suspension of titanium dioxide crystallites and mother liquid is rapidly cooled in cooling zone 3 to prevent further crystallization and crystal growth above certain sizes. Then obtained titanium dioxide products are separated from mother liquid 4 and collected in 5. Titanium rich solution is collected in 6 for concentration and other parameters adjustment and transferred into fed solution container 1. This continuous process provides means for production of brookite with desired properties.

Processes and Methods of Controlled Crystallites Size Rutile Preparation. A continuous process of the present invention for production titanium dioxide of rutile structure is based on previously disclosed batch method of M Gopal and others ( Journal of Materials Science, 1997, 32, 6001-6008, however, important modifications and improvements have been introduced. First, our process is not a batch process, but instead is a continuous process, in which freshly prepared and not dried (wet) amorphous titanium dioxide is dissolved in nitric acid to form a transparent and free from precipitates solution. The molar ratio of components in the solution is Ti: HNO₃: H₂O=0.02:0.04:60. The transparent and free from precipitates titanium nitrate solution is fed by peristaltic pump into a flow reactor which is constantly heated to 50° C. The tube reactor diameter and length is chosen to achieve almost immediate heating of solution to 50° C. The pumping rate is adjusted in such a way that the time of hot solution being in a flow reactor is from 10 to 60 minutes. The turbid suspension containing titanium dioxide crystals at the end of heated hydrolysis reaction zone is constantly withdrawn for analysis. Further hydrolysis and growth of the crystals is affected by relatively rapid cooling. Abortive cooling to stop crystal growth above certain sizes is a second important difference between our new method and prior art methods. Yield of titanium dioxide in this process is not as high as in processes which seek a full hydrolysis, however, the sizes of crystals are very uniform and could be easily kept below 100 Å. For titanium oxychloride solutions of various compositions and hydrolysis properties the time during which the solutions are present in heating zone is different and determined experimentally. Third, important difference of present invention method is an introduction of real time control step. Suspension of samples is constantly withdrawn from heated flow and is analyzed using powder diffractometer. First few reflections of solid are scanned, and then analyzed using Warren-Averbach method. Limited duration of heating is achieved by flow rate adjustment.

Referring to FIG. 4 titanium oxychloride solution 1 is fed into the heating zone of flow reactor 2 and heated continuously. Depending on concentration of components titanium containing solution hydrolyzes to form titanium dioxide of certain structure. At the end of heating zone the sample is constantly taken for rapid crystallite size analysis 7. To obtain the crystallites of desired structure, crystal sizes and yields the flow rate are adjusted 8. Upon reaching certain crystallite sizes the suspension of titanium dioxide crystallites and mother liquid is rapidly cooled in cooling zone 3 to prevent further crystallization and crystal growth above certain sizes. Then obtained titanium dioxide products are separated from mother liquid 4 and collected in 5. Titanium rich solution is collected in 6 for concentration and other parameters adjustment and transferred into fed solution container 1. This continuous process provides means for production of rutile with desired properties.

The preferred methods of making crystalline titanium dioxides that are described above consistently produce a product that consists predominantly, if not entirely, of anatase, brookite or rutile crystals having crystallite diameters below 100 Å. However, they could be also produced by other modified methods. The methods and adsorbents consisting of mixture of anatase, brookite and rutile crystals having essentially crystallite diameters below 100 Å in any combination are also disclosed by present invention.

Other materials containing titanium oxide products also may be produced in accordance with this process. For example, a particulate substrate, such as granular activated carbon, alumina, silica, clays may be added to the solution and coated with titanium in similar conditions to precipitate the titanium oxide onto the surface or into the pores of the particulate substrate.

Present invention further comprises methods of using quantum size effect enabled titanium dioxides in water treatment processes. We have performed many batch and column tests for removal of dissolved contaminants from water using anatase, brookite and rutile as well as from samples containing the mixtures of thereof. We have found that all these three crystalline compounds are highly efficient adsorbents of ions and molecules provided their crystal sizes are in disclosed in present invention range. They have a high adsorptive capacity and favorable adsorption kinetics for removing oxyanions, such as arsenate and arsenite, phosphates, dissolved metals and some low-molecular weight organic compounds at low concentrations in water—properties which lead to high rates of removal for those substances. The crystalline titanium dioxides of present invention may be used to substantially reduce the concentrations of such substances to concentrations below a few micrograms-per-liter (μg/L). Substances which may be effectively adsorbed by the crystalline titanium dioxides of present invention include but not limited to aluminum, antimony, arsenic(III), arsenic(V), barium, cadmium, cesium, chromium, cobalt, copper, gallium, gold, iron, lead, manganese, mercury, molybdenum, nickel, platinum, radium, selenium, silver, strontium, tellurium, tin, tungsten, uranium, vanadium, zinc, nitrite, phosphate, sulfite, sulfide, and low-molecular weight organic arsenic compounds, such as monomethylarsonic acid, dimethylarsinic acid and phenylarsonic acid. In particular, the crystalline titanium dioxides of present invention are effective in adsorbing arsenite (As(III)), arsenate (As(V)) and the dissolved metals: cadmium, chromium, copper, lead, mercury, tungsten, uranium, zinc and others.

Dissolved inorganic substances may be removed from a dilute aqueous stream by contacting the dilute aqueous stream with the crystalline titanium oxides of present invention for a period of time. Preferably, the crystalline titanium dioxides comprises anatase, brookite and rutile, all these materials being particularly effective in removing arsenic and dissolved metals from water, as disclosed herebelow in the Examples. For convenience, the following methods of removing dissolved inorganic substances from water are discussed with respect to the use of anatase, brookite and rutile. However, many other contaminants may also be removed from water according to the methods hereinafter disclosed.

A dilute aqueous stream may be contacted with titanium dioxide of disclosed characteristics by known water treatment processes, e.g., suspending a powdered titanium dioxide in a batch or a stream of contaminated water for a period of time, then separating the titanium dioxide solids from the water, or by filtering the dilute aqueous stream through a bed or column of the titanium dioxide product. The titanium dioxides of present invention could be used in water treatment processes in a powdered or granular form; it may be dispersed in a bed of a particulate substrate; or it may adhere to the surface or be within the pores of a particulate substrate such as granular activated carbon, porous alumina, porous silica or any other support material.

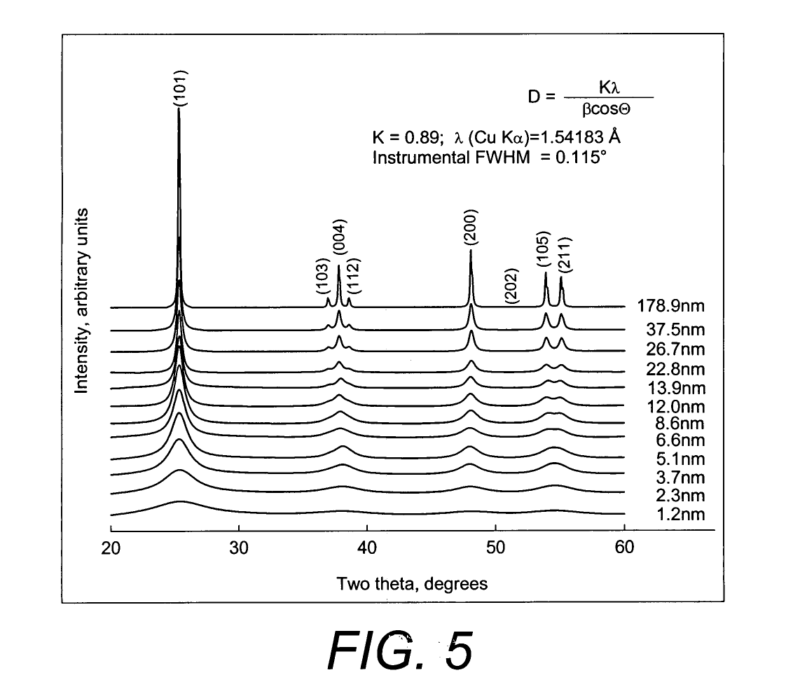

Referring to FIG. 5 the powder diffraction patterns of samples consisting of anatase titanium dioxide, essentially free from other crystalline and amorphous phases are shown. These samples were prepared to test their properties as adsorbents. These kinds of samples normally would be described in scientific and patent literature as an ultrafine, nanocrystalline and other terms to signify the fact that they contain very small crystallites. However, as present invention discloses here, they are significantly different from each other: some of them are practically not useful to practice the advantages of present invention. Crystallite sizes shown have been determined by spherical crystal approximation using Scherrer equation. It is obvious that the shapes of crystal are not spherical and Scherrer approximation has little use to prove the main embodiment of present invention. What is needed is to determine the crystallite sizes in more accurate manner and also determine the crystallite size distribution. There are many, in fact, too many, publications using so called “naked-eye”, Scanning Electron Microscopy (SEM), Scherrer equation or simple believe for estimation of the crystal sizes. For example, U.S. Pat. No. 6,001,326 to Kim and others and U.S. patent application publication No. 6,516,804 B1 to Kim and others estimate the crystal sizes by Scanning Electron Microscopy. However, it is not described which SEM instrument was used, what was the resolution of SEM instrument. It is well known that currently available SEM instruments are neither able of resolving in 10 nm range nor that these resolutions are reliable. For example, FIG. 3-FIG. 6 of patent (U.S. Pat. No. 6,001,326) show that the sizes of particles are absolutely not uniform; in fact the difference in sizes was more than 100 times.

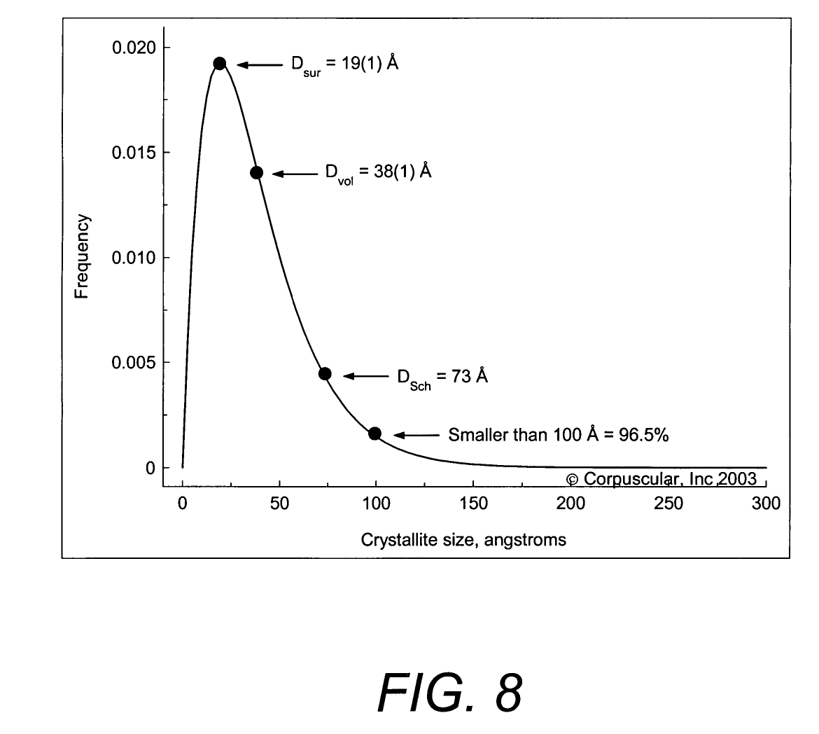

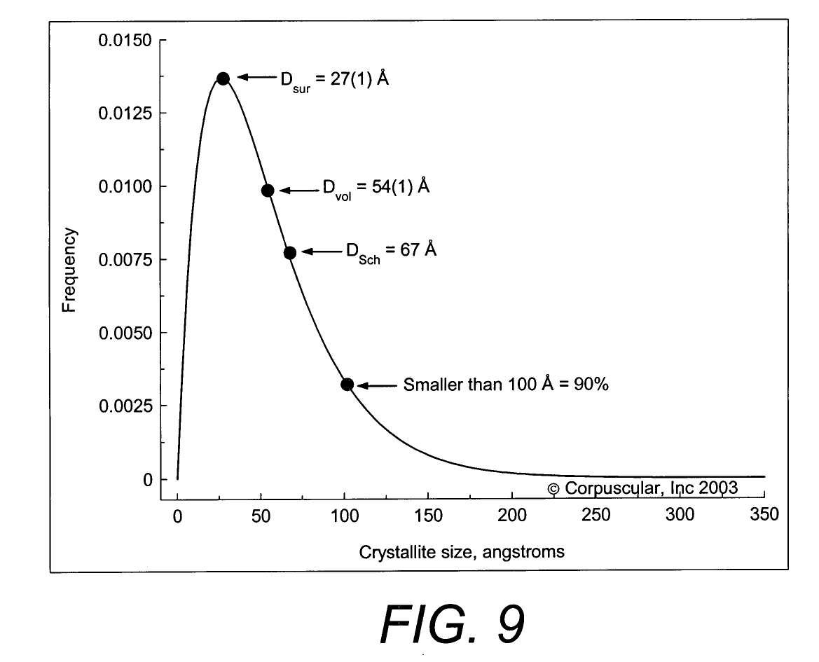

To eliminate such uncertainties we have undertaken more rigorous determination of crystallites sizes and dependency of adsorption properties from crystallite size. FIG. 8 is Warren-Averbach crystallite size distribution for anatase sample of present invention. Spherical approximation of crystallite diameter estimated by Scherrer equation shows D(Scherrer)=73 Å. In reality, volume weighted crystal size is D(vol)=38 Å and surface weighted crystal size D(sur)=19 Å Integration of lognormal distribution function shows that 96.5% percent of crystals are smaller than 100 Å. The ratio of volume weighted crystallite size (VWCS) to surface weighted crystallite size (SWCS) is equal to 2. FIG. 9 shows the results of analysis of another sample by above method and crystallite sizes are shown in D(Scherrer)=67 Å, D(vol)=54 Å and D(sur)=27 Å. This sample consisted of pure anatase and had about 90% crystals smaller than 100 Å with VWCS/SWCS=2. Following discussion is important for understanding of present invention and particularly for understanding of novelty of adsorbents prepared using these crystals and directly related to their performance as adsorbents. It is an important and determinative feature of present invention which states that the sample of FIG. 8 will have more adsorption capacity, and faster adsorption rates than the sample of FIG. 9, since the former has smaller crystallite size and more crystals below 100 Å, which would be opposite if we had used spherical crystal approximation.

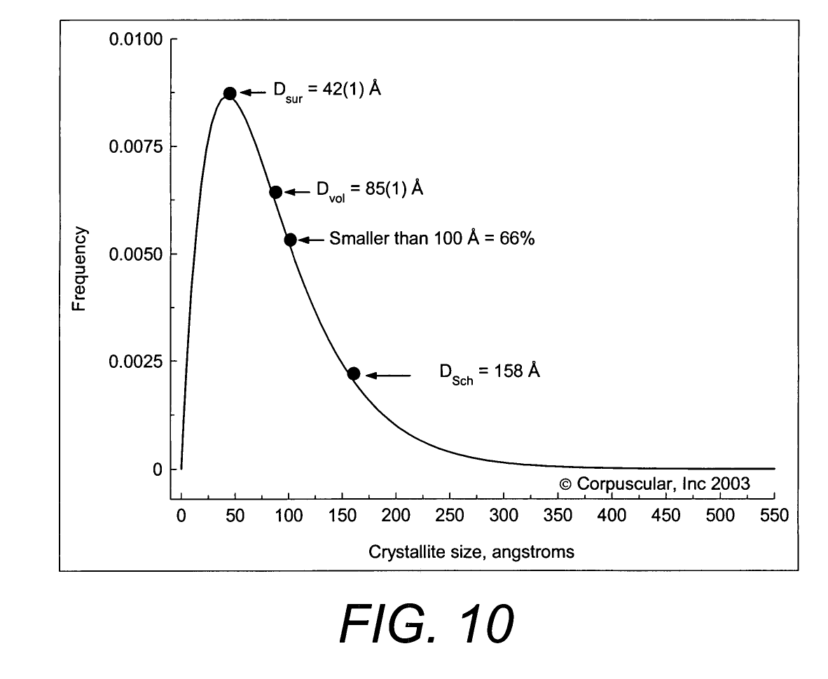

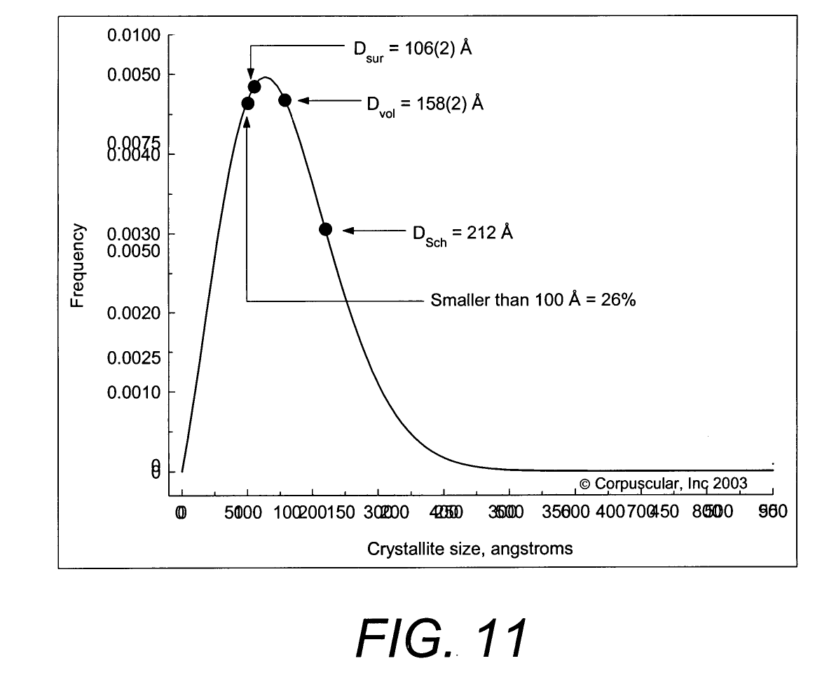

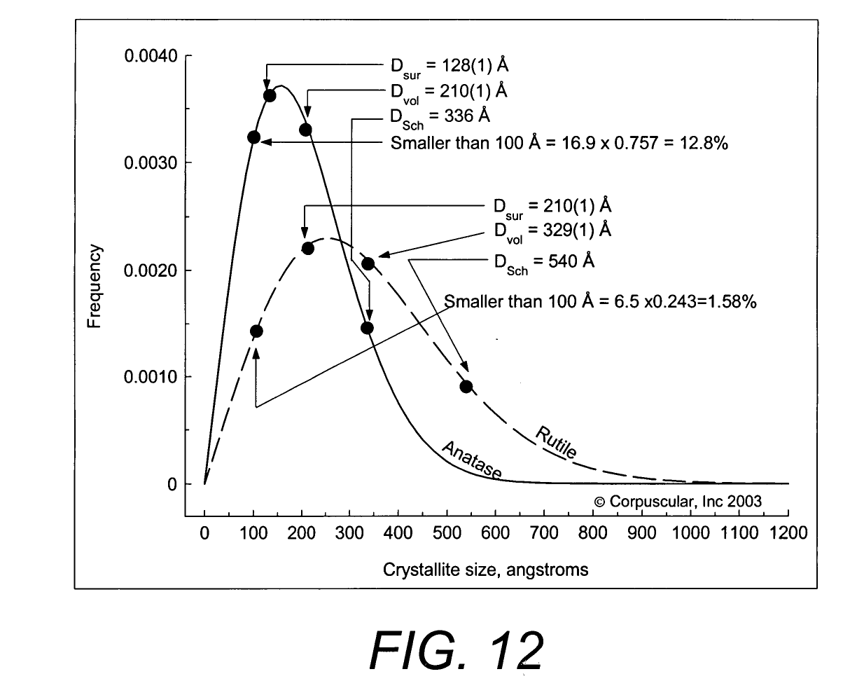

We have prepared and investigated numerous samples prepared via continuous process offered by present invention. For example, sample analyzed in FIG. 10, FIG. 11, FIG. 12 (P-25™ sample from Degussa). The adsorbents of present invention are self-limited to those containing titanium dioxide crystals below 100 Å, they should be present at least in quantities 15%. It is a scientific result of present invention that above 100 Å the crystals rapidly loose their adsorptive properties proportionally to their crystal size. For example sample of FIG. 10. D(Scherrer)=158 Å, D(vol)=85 Å and D(sur)=42 Å contains only 66% percent of crystals below 100 Å. Even though the Scherrer size is 158 Å, this sample according to present invention will have a certain adsorption properties and these adsorption properties are due to present small crystals. The sample shown in FIG. 11 has very limited amount of crystals smaller than 100 Å (26%). The D(vol)=158 Å.

P-25™ from Degussa is currently one of commonly investigated commercial titanium dioxides and is widely used as a photocatalyst for degradation of contaminants. Rietveld quantification analysis of P-25™ shows that it is a mixture of anatase (75.7%) and rutile (24.5%). Crystallite size and crystallite size distribution of P-25™ shows D(Scherrer)=336 Å, D(vol)=210 Å and D(sur)=128 Å for anatase and D(Scherrer)=540 Å, D(vol)=329 Å and D(sur)=210 Å for rutile crystals. This sample contains only 12.8% percent of crystals below 100 Å due to anatase and 1.58% due to rutile. Again, this is important for understanding and appreciating of present invention over prior art. According to embodiments and claims of present invention, in spite of P-25™ having more than 75% anatase with volume weighted crystallite size of 210 Å, it will have very insignificant to none useful properties which could be used to practice the advantages offered by present invention. Even though P-25™ has useful properties as a photocatalyst, it cannot be successfully used for adsorption of contaminants from aqueous systems contrary to the adsorbents of present invention. Thus, this example shows that there is no direct dependence between the photocatalytic properties of titanium dioxides and their ability to function as adsorbents.

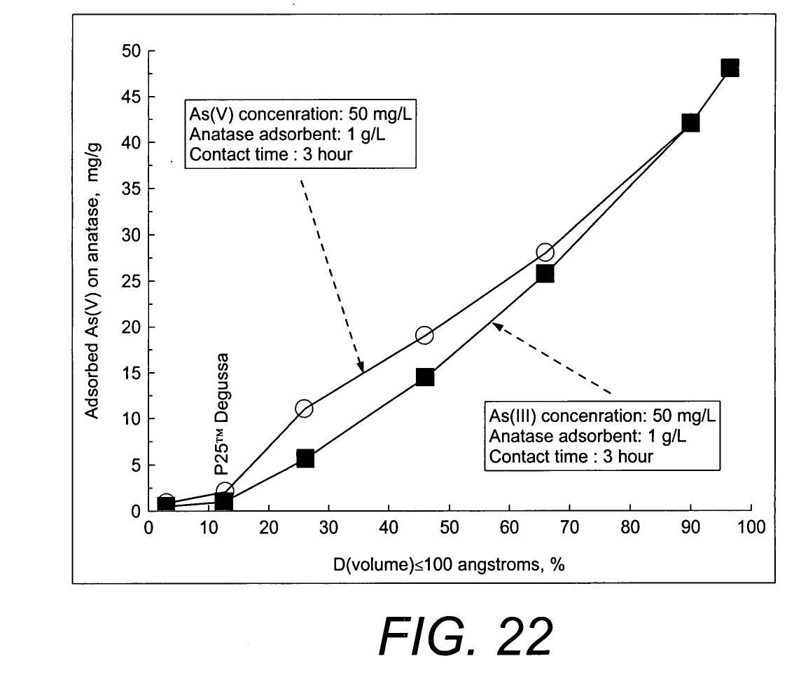

Now, referring to FIG. 22, which is a graphical representation of adsorption properties obtained under the same experimental conditions. Briefly, 0.1 gram of each sample just described above were contacted with 100 ml of As(V) in first series of experiments and 100 ml of As(III) in a second series of experiments. The concentration of As(V) and As(III) was 50 ppm (mg/L). As evidenced by obtained results and plotted in this FIG. 22, the amount of adsorbed As(V) as well as of adsorbed As(III) is directly related to the amount of present small crystals. Oxidation of As(III) to As(V) was also directly influenced by the quantity of small crystals.

Use of titanium dioxide of brookite structure, as an adsorbent of water contaminants is not suggested by the references. In fact, the synthesis brookite has been described only very recently. In ‘Background of the Invention’ section we gave detailed account of prior art of brookite-related scientific and patent publications.

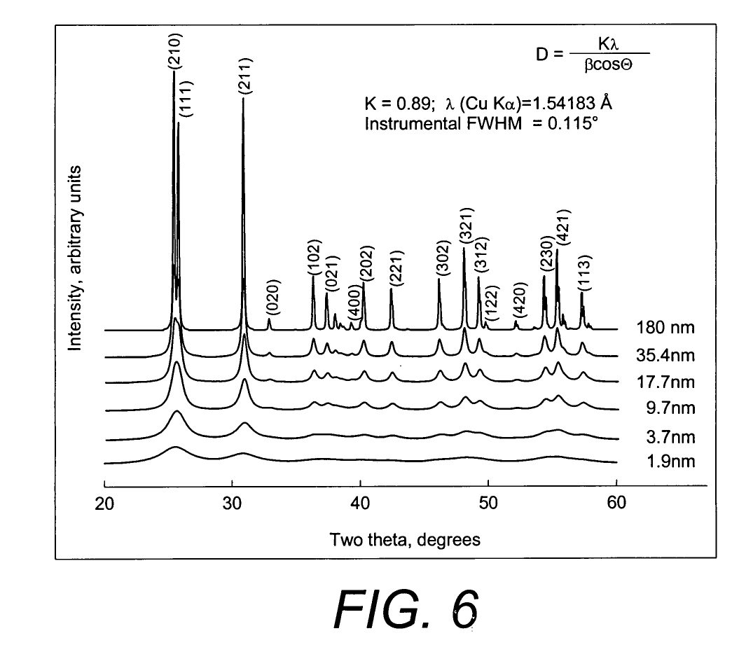

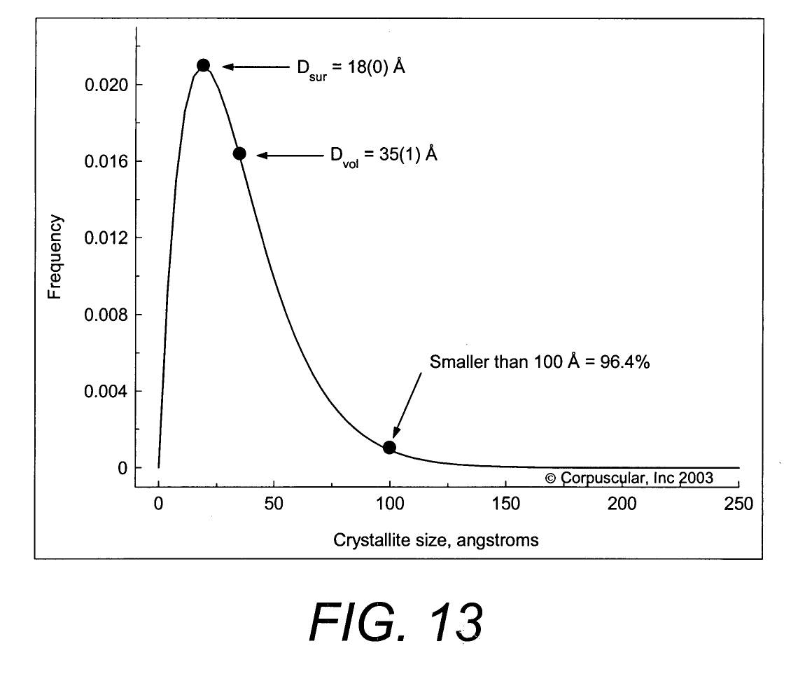

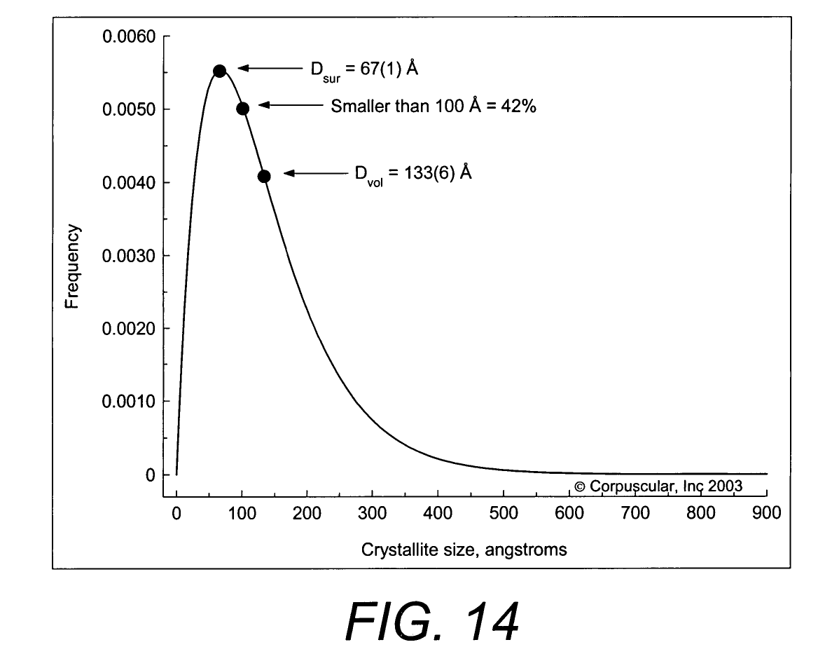

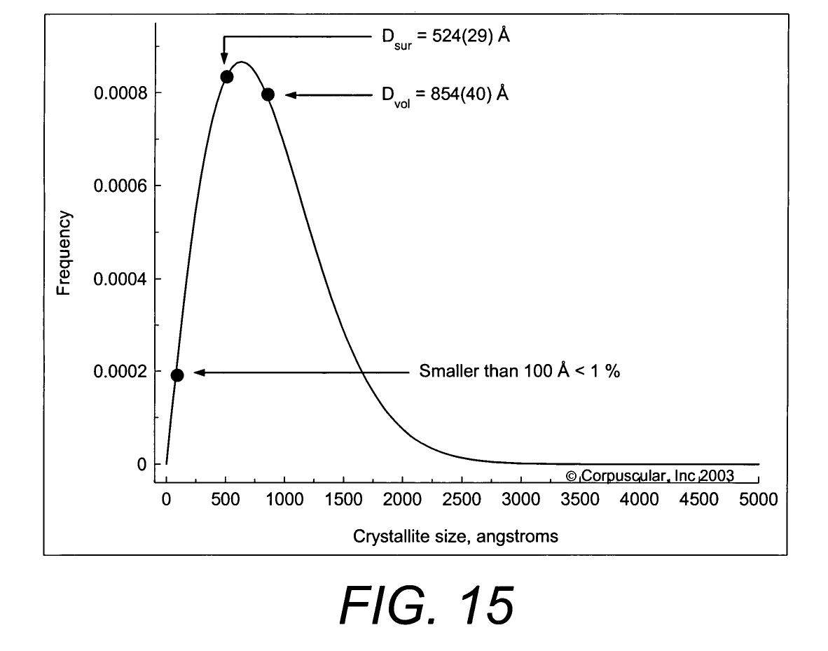

We have prepared by methods of present invention numerous pure single-phase brookite samples. Representative samples of brookite titanium dioxide with different crystallite sizes are shown in FIG. 6. The crystallite sizes and crystallite size distribution are determined in similar fashion as for anatase samples, just described above. The FIG. 13, FIG. 14 and FIG. 15 are examples of crystallite size distribution for some brookite samples.

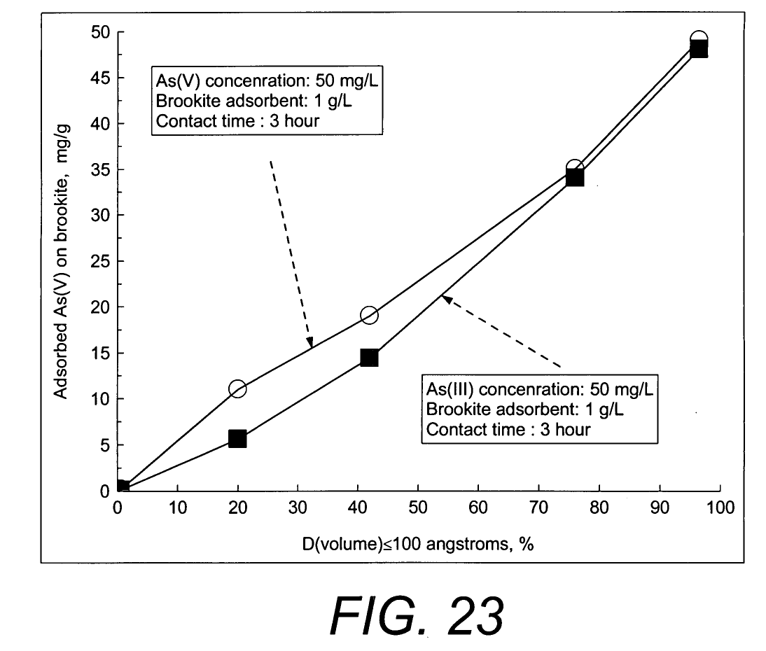

Now, referring to FIG. 23, which is a graphical representation of adsorption properties obtained under the same experimental conditions. Briefly, 0.1 gram of each brookite sample just described above were contacted with 100 ml of As(V) in first series of experiments and 100 ml of As(III) in a second series of experiments. The concentration of As(V) and As(III) was 50 ppm (mg/L). As it evidenced by obtained results and plotted in this FIG. 23, the amount of adsorbed As(V) as well as of adsorbed As(III) is directly related to the amount of present small crystals. Oxidation of As(III) to As(V) was also directly influenced by the quantity of small crystals. It should be noted that, adsorption of arsenic on brookite-based adsorbents as effective as on anatase-based adsorbents. In fact, the brookite-based adsorbents are on average 2-5% better performing than similar samples of anatase-based adsorbents.

Use of titanium dioxide of rutile structure, as an adsorbent of water contaminants is not suggested by the references. In fact, the synthesis of rutile in low nanosized range has been described only very recently. In Background of Invention we gave the detailed account of prior art of rutile-related scientific and patent publications.

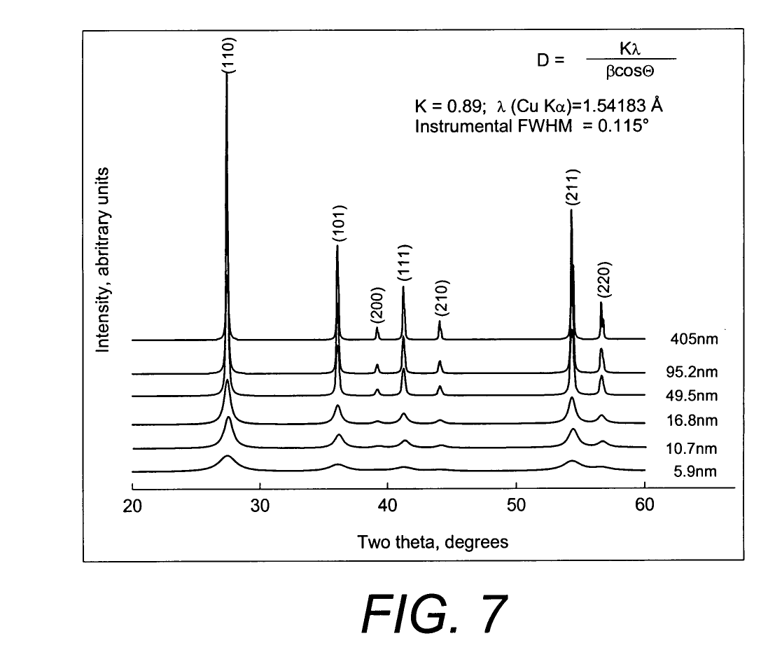

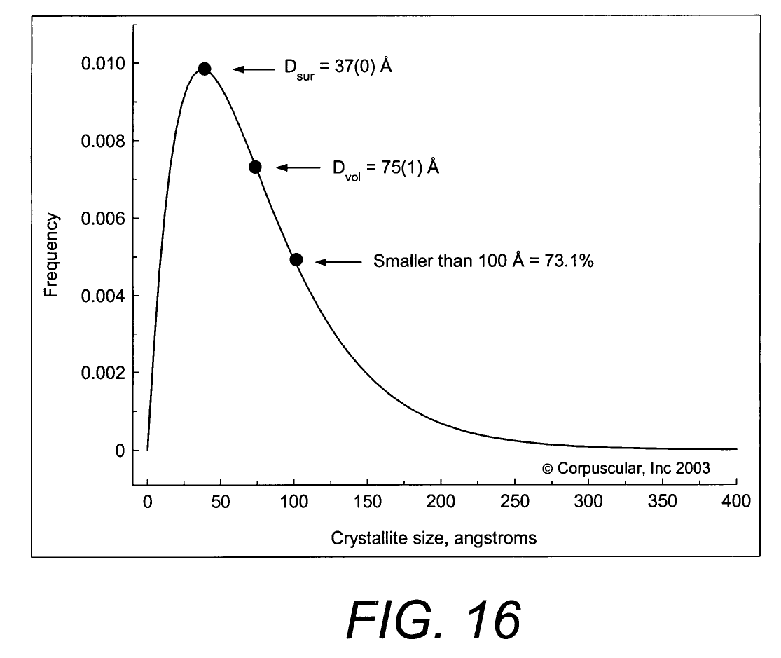

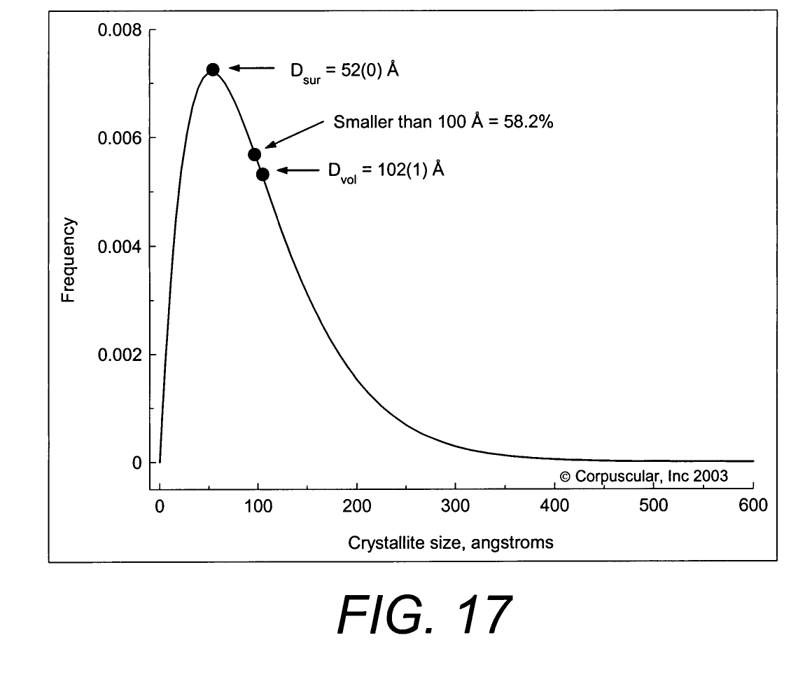

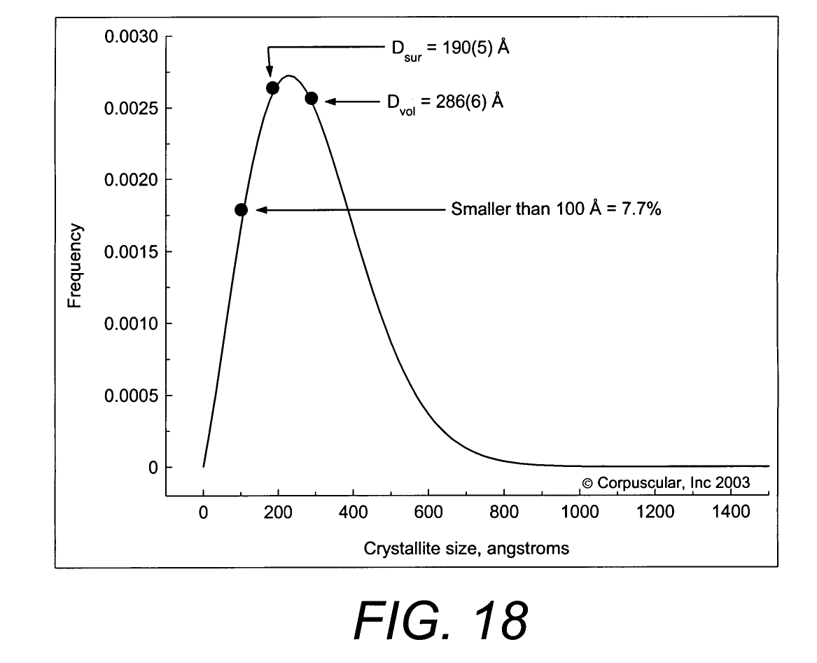

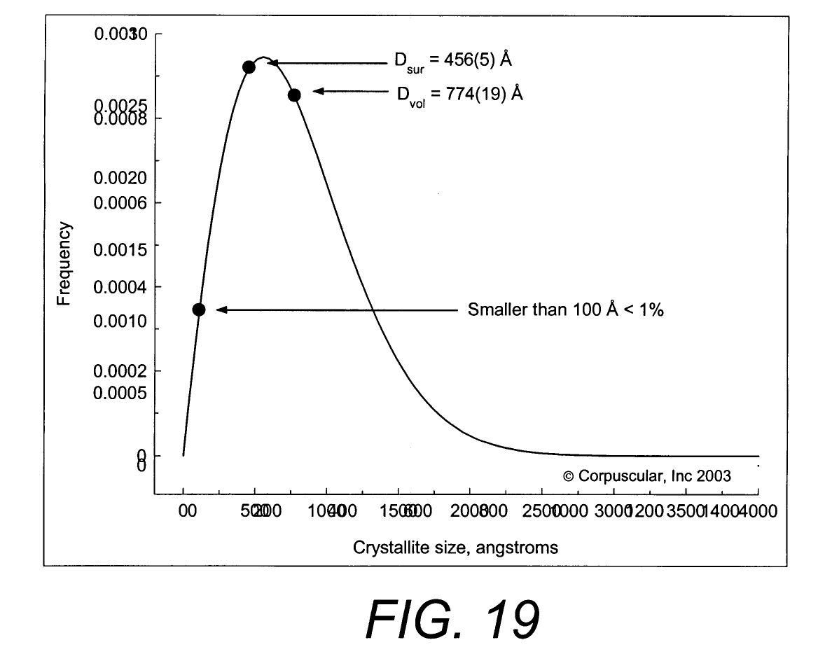

We have prepared by methods of present invention numerous pure single-phase rutile samples. Representative samples of rutile titanium dioxide with different crystallite sizes are shown in FIG. 7. The crystallite sizes and crystallite size distribution are determined in similar fashion as for anatase and brookite samples, just described above. The FIG. 16, FIG. 17, FIG. 18 and FIG. 19 are illustrations of crystallite size distribution for some rutile samples.

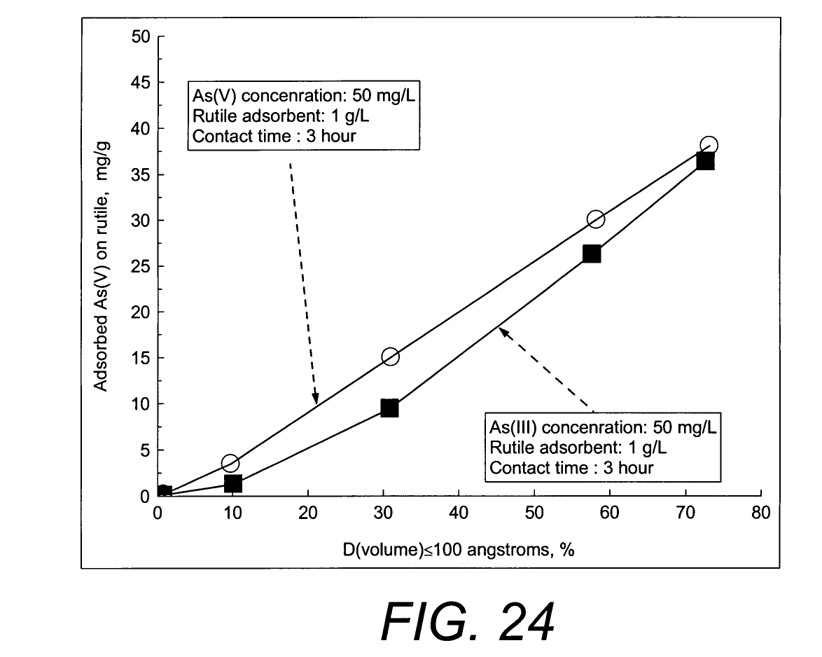

Now, referring to FIG. 24, which is a graphical representation of adsorption properties obtained under the same experimental conditions. Briefly, 0.1 gram of each rutile sample just described above were contacted with 100 ml of As(V) in first series of experiments and 100 ml of As(III) in a second series of experiments. The concentration of As(V) and As(III) was 50 ppm (mg/L). As evidenced by obtained results and plotted in this FIG. 24, the amount of adsorbed As(V) as well as of adsorbed As(III) is directly related to the amount of present small crystals. Oxidation of As(III) to As(V) was also directly influenced by the quantity of small crystals. It should be noted that, adsorption of arsenic on rutile-based adsorbents was also very effective.

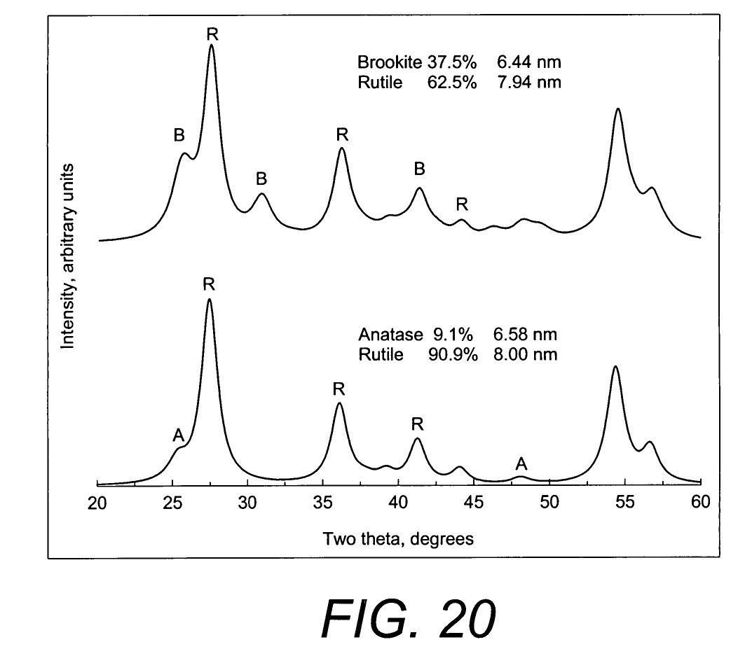

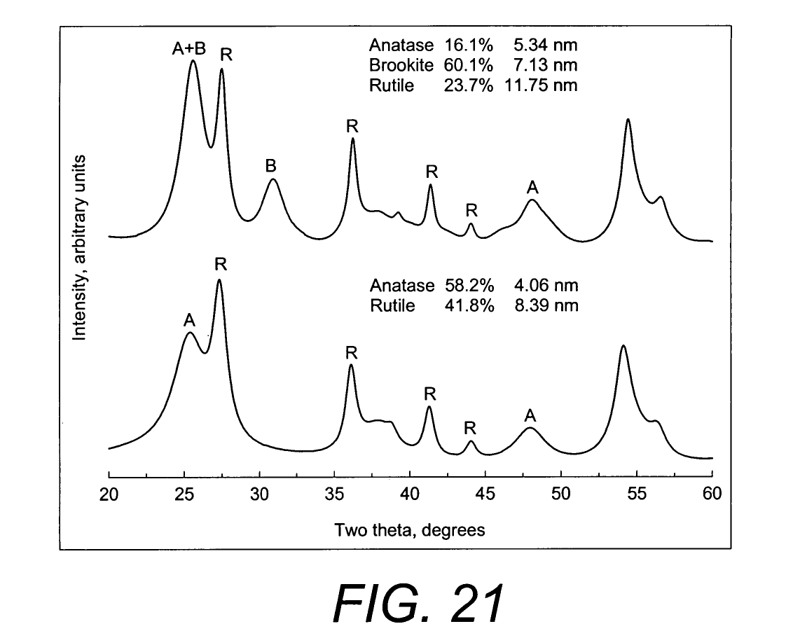

Preceding description of adsorption of arsenic on anatase, brookite and rutile, when they have a suitable crystallite size and crystallite size distribution, suggested that the mixtures and intergrowth of the same crystals most probably would also have favorable adsorption properties. FIG. 20 and FIG. 21 depict the X-ray powder diffraction pattern of such binary and ternary mixture, with quantified amounts of each phase. Quantification of phases is performed by Rietveld quantification method and crystallite sizes are determined by Warren-Averbach method. We have been able to prepare many such samples during pure rutile synthesis. The process was found to be very sensitive in regard to composition of initial solution and duration of crystallization. However the crystal sizes in each phase were usually within desired range.

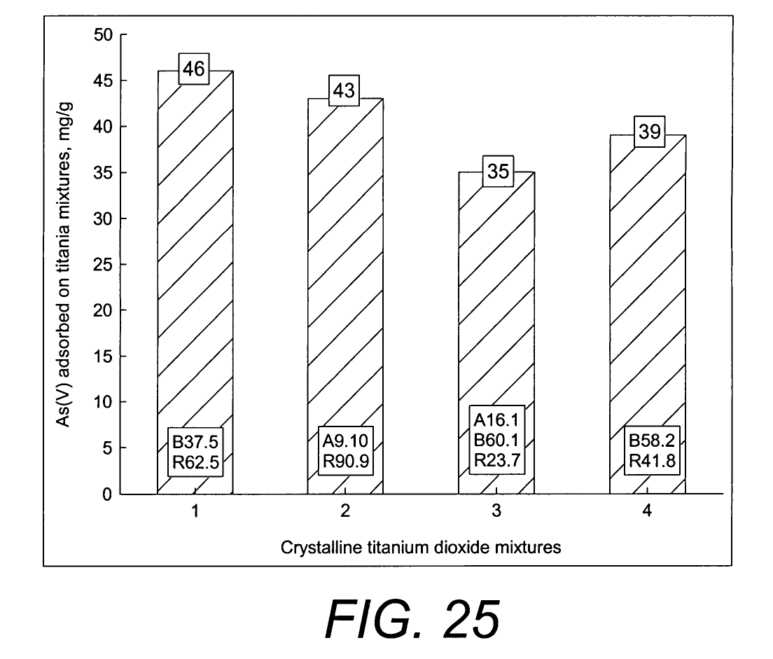

Now, referring to FIG. 25, which is a graphical representation of adsorption properties obtained under the same experimental conditions. Briefly, 0.1 gram of each binary and ternary mixture samples just described above were contacted with 100 ml of As(V). The concentration of As(V) was 50 ppm (mg/L). As it evidenced by obtained results and plotted in this FIG. 25, the amount of adsorbed As(V) was again directly related to the amount of present small crystals. It should be noted that, adsorption of arsenic on binary and ternary mixtures of titanium oxide adsorbents was also very effective.

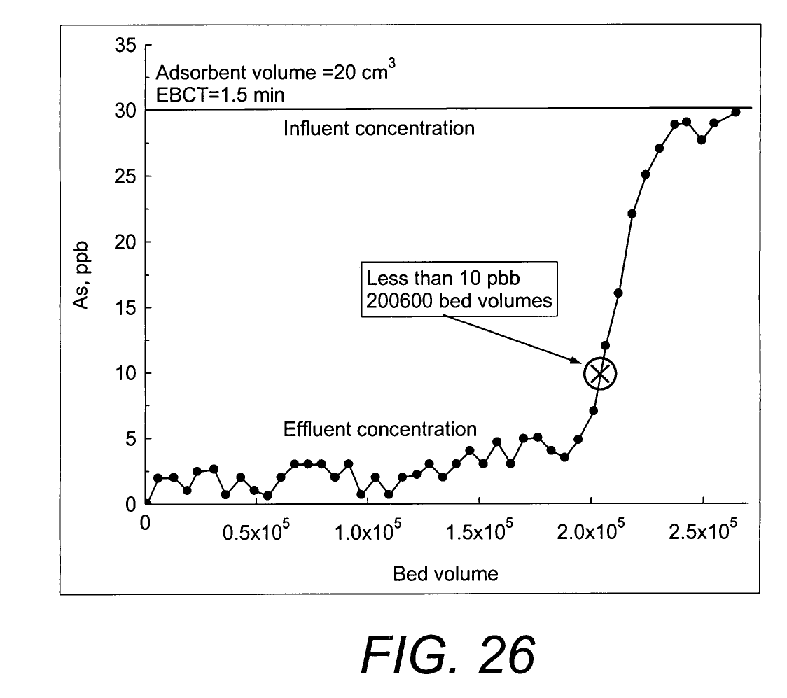

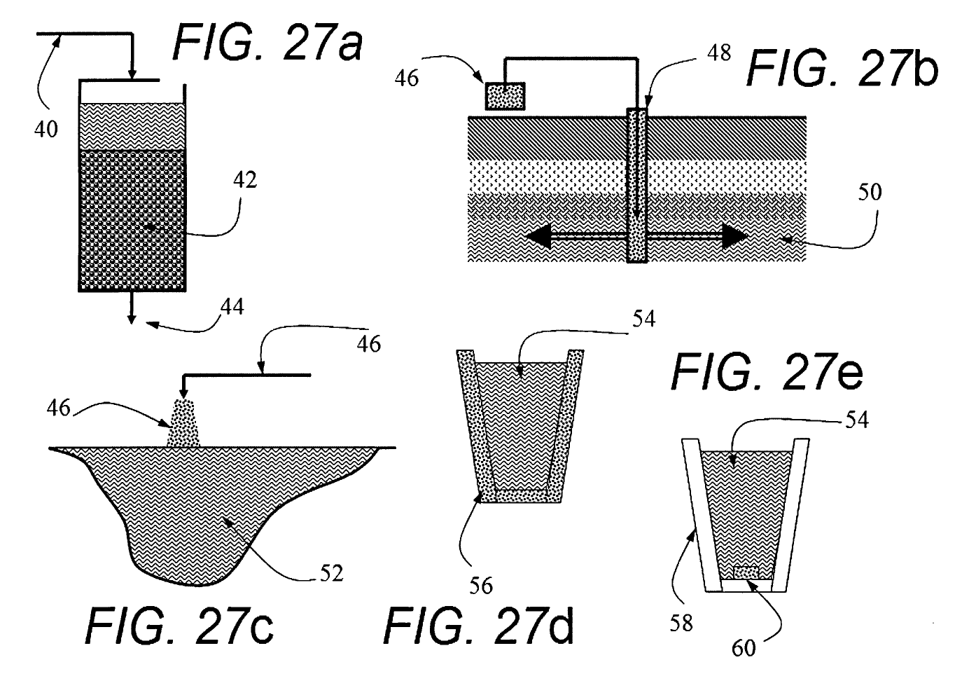

Referring to FIG. 26 showing the dynamic adsorption characteristics of titanium dioxide of present invention. The experimental details are described in Example 16. It shows that 20 cm.sup.3 adsorbent was capable of treating more than 1,000 gallons of water to reduce the concentration of dissolved As from 30 ppb to 10 ppb which is US EPA starting 2006 mandated drinking water standard.

The effectiveness of crystalline titanium dioxides of present invention, specifically, anatase, brookite and rutile structures in removing arsenate, arsenite and other dissolved inorganic substances from water is an unexpected result in view of the conventional understanding that the adsorption capacity of a metal oxide is controlled by the availability of hydroxyl groups on the surface of the metal oxide product (see, e.g., U.S. Pat. No. 5,618,437, col. 4, lines 26-30, and U.S. Pat. No. 6,383,395, col. 7, lines 49-53). A hydrous and amorphous titanium hydroxide should have a greater number of available hydroxyl groups than a crystalline titanium oxide and, therefore, would be expected to exhibit a greater adsorptive capacity according to the conventional understanding. Contrary to this expectation, the titanium dioxides of the present invention have higher adsorptive capacity than the amorphous titanium oxides, hydrous titanium dioxides and any other known titanium oxygen compounds. Moreover, the favorable adsorption kinetics of the titanium oxides of the present invention are observed in the absence of acidic anions, such as chloride or sulfide, in contrast to expectations based on the disclosure of the Japanese Patent Application Publication 58-045705.

### Areas of Application

Present inventions provide a broad base and open possibilities for application of these highly effective adsorbents in various areas. The adsorbents replace currently used materials in existing adsorption based water treatment processes, including industrial, municipal, regional water treatment facilities. The small units could be used in Point of Entry (POE) and Point of Use (POU) systems. The columns filled with these adsorbents have no limitations in size, shape etc. The solid adsorbent could be used in powdered, granulated, and coated on substrate forms.

Particularly important area of application for adsorbents of the present invention is application of them as sols. Crystallites of such small sizes are easily stabilized in weak basic, neutral and acidic solutions to form stable sols. These sols contain the materials without degradation of adsorption properties of titanium dioxides of the present invention. Thus they could be injected into aquifer, ground water systems, soils contaminated with undesired molecules and ions where they will adsorb the contaminants and adhere to the soil particles, thus providing the barrier for migrating contaminants.

The sols and fine powder could be used to treat the contaminated lakes, liquid waste basins, just by spreading them over water to bind the contaminants and precipitate.

Adsorbents of the present invention could be used to coat paper and plastic drinking cups or any other drinking water devices, storage units and others.

Adsorbents of the present invention could be used to separate, isolate, and concentrate radionuclides.

Without further elaboration, it is believed that one skilled in the art, using the preceding description, can utilize the present invention to its fullest extend. The following preferred specific embodiments are therefore to be construed as merely illustrative of the remainder of the disclosure in any way whatsoever.

Prior to the description of specific examples for carrying out the best modes of present invention with characteristic variables, we would like to describe the methods which were applied throughout all experiments.

It will be appreciated the foregoing is merely illustrative of art-recognized methods and instruments for investigation of composition, structure, properties of solid materials, however, if it is in question the methods described are preferred.

### Experimental Methods

Below we describe various experimental methods

X-ray Powder Diffraction Instrumentation and Data Collection. Step-scanned X-ray powder diffraction data for the powdered samples were collected using well aligned with less than 0.01 zero shift and instrumental line broadening of about 0.07 degrees of two theta X-ray powder diffractometer (trademark: Rigaku DXR-3000, Rigaku/MSC Corporation, The Woodlands, Tex.) using Bragg-Brentano geometry, an copper (Cu) anode operating at 40 kV and 30 mA, and equipped with a diffracted beam graphite-monochromator. Measurements were taken using a 1 degree divergence and 1 degree scatterer slits and a 0.15 mm receiving slit. CuKa radiation from the Cu anode, i.e., radiation having a wavelength of 1.54183Å, was used as the X-ray source. Data were collected between 20 degree-60 degree of two theta, which represents two times the Bragg angle of diffraction with a step size of 0.05 degree and a count time of 5 seconds per step. Highly crystalline and well characterized standard silicon powder (NBS 640, a=5.43088 Å) were used to correct the two theta values and also evaluate instrumental broadening.

Crystalline Phase Identification. The interplanar distances (d) were calculated using Bragg's law:
2d sinθ=nλ
where θ is the Bragg angle of diffraction; λ is an integer value; and X is the wavelength of the X-ray source, in this case, λ=1.54183 Å. Obtained interplanar distances with their corresponding intensities were compared against PDF2 database manually and using automatic search-match procedures. In present invention the samples showing a diffraction pattern matched with that of given for anatase (for example, PDF No 21-1272), brookite (for example, PDF No 29-1360) and rutile (for example, PDF No 21-1276) PDF-2 database published by ICDD (The International Centre for Diffraction Data). The phase identification of samples comprising single phases and also mixtures were determined in similar fashion.

Crystalline Phase Quantification. Crystalline samples were quantified by Rietveld quantification method (The Reitveld method Editor R. A. Young, Oxford University Press, 1993). Briefly, using the structural data given in ICSD for anatase, brookite and rutile and CSAS (Generalized Structure Analysis System, by A. C. Larson and R. V. Dreele, LANSCE, MS-H805, Los Alamos National Laboratory, Los Alamos, NMN 87545 USA) Rietveld refinement software the observed diffraction pattern were fitted to obtain best fit between observed and calculated patterns and then the scale factor was normalized to obtain final concentration of present phases. The quantification analyses of samples were confirmed also by commercial analysis performed for us by XRD.US (http://www.xrd.us).

Crystallite Size and Crystallite Size Distribution Determination. The sizes of individual crystals and crystals in crystalline agglomerates were determined to evaluate the relationship between crystallite size and crystallite size distribution and adsorption properties. Primary crystallite diameters (d.sub.0) were calculated by the Scherrer equation:
d₀=Kλ/βcosθ
where K have value of 0.89; λ is the wavelength of the X-ray source, in this case, λ=1.54183 Å; β is the FWHM (full width of half maximum), free from instrumental line broadening, expressed in radians, and θ is the Bragg angle of diffraction. The calculated primary crystallite diameters for the titanium oxide product obtained by the Scherrer equation were consistently higher than those estimated by Fourier methods, even though this method is most commonly used among non-specialists. Unfortunately, using the above techniques we repeatedly obtained different adsorption results for samples of the same structure and surface area and the same Scherrer crystallite diameter.

However, to test the main hypothesis and major embodiments of present invention we had to employ more vigorous methods of crystallite size determination. Because of crucial importance of crystallites sizes and even more importantly of crystal size distribution it was treated by Warren-Averbach method. (B. E. Warren, X-ray Diffraction, Addison Wesley, Reading, Mass., 1969; H. P. Klug and L. E. Alexander, X-ray Diffraction Procedures, 2nd edition, John Wiley, New York, 1974). For the details of calculations of the root-mean-square strain (RMSS) and both surface- and volume-weighted domain sizes according to the double-Voigt method see, for example, D. Balzar and H. Ledbetter, J. Appl. Cryst. 26 (1993) 97-103 and 3. D. Balzar, J. Res. Natl. Inst. Stand. Technol. 98 (1993) 321-353. Briefly, if the distortion coefficient is approximated by a harmonic term, the size and distortion integral breadths of Caucy (β_{SC} and β_{DC}) and Gauss (β_{SG} and β_{DG}) parts conform certain relations. To determine the unknowns β_{SC}, β_{DC}, β_{SG} and β_{DG} data for at least two reflections must be available. If data for more than two peaks are present, unknowns are calculated by means of the linear least squares fit. In our analysis we have used all reflections for brookite, anatase and rutile located between 20 and 60 degrees of two theta. Surface and volume weighted domain sizes are derived directly from calculation along with their distributions.

Surface Area and Porosity Determination. The samples of titanium dioxide powders were dried at a temperature of 110.degree. C. for one hour. The BET specific surface area and the porosity of the samples were determined by a static volumetric gas adsorption technique. Measurements were taken using a gas-absorption/desorption analyzer (trademark: ASAP 2010, Micromeritics, Norcross, Ga.). A sample tube containing the sample of titanium dioxide was cooled in liquid nitrogen and evacuated to de-gas the sample. Measured amounts of nitrogen gas were then introduced and the amount of nitrogen adsorbed by the nano-crystalline anatase was determined under different pressures. The resulting data, i.e., curves of the volume of nitrogen adsorbed vs. the relative nitrogen pressure, were reduced using the BET equation to determine the BET specific surface area of the sample and using the BJH method to determine pore size distribution.

Surface Hydroxyl Group Determination. An acid-base titration method was used to determine the number of the surface sites. Anatase titanium dioxide powder was added to pure Millipore deionized water to make 100 ml of 10 g/l TiO₂ suspension. The pH of the suspension was lowered to pH 3.0 using HCl, then the mixture was purged for 2 hrs with nitrogen gas to remove dissolved carbon dioxide. After purging, the pH of suspension was raised to the Point of Zero Charge (PZC)=5.8 determined by zeta potential measurements, and allowed to rest for 24 hours. The suspension was assumed to be in complete equilibrium, and excess amount of HCl was added and allowed to saturate the suspension for another 24 hours. When completely saturated, the solids in suspension were separated with a 0.2-micron membrane filter, and the supernatant was back-titrated to pH 5.8 with NaOH. The number of surface sites was calculated by subtracting the number of moles of the back titrant, NaOH, from the initial number of moles of HCl added, and dividing the result by the weight of the titanium dioxide used

### EXAMPLE 1

Preparation of Crystalline Titanium Dioxide of Brookite Structure with D(vol)(54 Å). Titanium sulfate solution with composition similar to that of used industrial titanium dioxide production by sulfate process was prepared having the composition of 250 gram per liter of TiO₂, weight ratio of free sulfuric acid to TiO₂ of 1.90:1 and weight ratio of ferrous sulfate to TiO₂ of 0.8:1. This solution was fed using peristaltic pump into the glass tube with 10 mm internal diameter and length located inside the constantly heated silicon oil bath with temperature of 105° C. The feed rate was 2 ml per minute. The transparent solution became turbid while moving inside the glass tube. After 10 minute in the heating zone, the suspension was rapidly cooled by dividing it into smaller 0.3 mm diameter tubes cooled by ice filed water bath. Solid titanium oxide suspension was separated by centrifuging of suspension. X-ray powder diffraction analysis showed that the solid consisted entirely of anatase, with broad diffraction lines. Crystallite size determined by Scherrer equation was 66 Å. Crystallite size distribution determined by Warren-Averbach method is shown in FIG. 13. Volume-weighted crystallites size was 54 Å and more than 90 percent of crystals were smaller than 100 Å. The sample was determined to have a BET specific surface area of about 340 m²/gm and a total pore volume of 0.42 cm³/gm for pores with diameters of less than 0.63 μm. Yield of titanium dioxide was 65 weight percent.

### EXAMPLE 2-13

Preparation of Crystalline Titanium Dioxide of Anatase Structure with Different Crystallite Sizes. Crystallite Size Distribution Analysis. The same solution used in experiment of Example 1 was treated in similar fashion by varying the time of heating, which was easily achieved by adjusting the pumping rate. The solid samples separated from suspensions were analyzed using powder diffraction. Some samples were heated at various temperatures. Powder diffraction patterns of these samples are presented in FIG. 5. Crystallite size distributions of the samples obtained are shown in FIG. 8, FIG. 9, FIG. 10, and FIG. 11. Comparative analysis of P-25™ from Degussa is shown in FIG. 12.

### EXAMPLE 14

Surface hydroxyl group determination for anatase samples. The available surface hydroxyl content of the sample of FIG. 9 was determined to be about 2.7 mmol/gm of nano-crystalline anatase. The available hydroxyl content of the sample of FIG. 11 was determined to be about 0.6 mmol/gm.

### EXAMPLE 15

Batch adsorption test using anatase samples of present invention. Batch adsorption of As(V) and As(III) from spiked tap water. Anatase samples obtained in examples 1-14 were used to determination of adsorption properties. Aqueous samples of the arsenate (As(V)) and arsenite (As(III)), were prepared for testing by dissolving salts of the selected substances in tap water to the initial concentrations of 50 mg/l. Batch experiments were conducted by adding the anatase samples to each aqueous sample, to obtain the titanium oxide concentration of 1 g/l and suspending the anatase powder in the aqueous sample by mixing for about three hours. The results (FIG. 22) show that anatase not only effectively removed As(V), but also As(III) in a relatively short time, i.e., three hours or less. The high degree of arsenite (As(III)) removal is particularly noteworthy, since conventional adsorbents, such as alumina or ferric hydroxide, are known to have much lower capacities for removal of this oxyanion. It is also important to note that, the conversion of As(III) to As(V) and its adsorption are achieved on samples containing the higher percentage of smaller crystals. These tests demonstrated that presence of chloride, or of other acidic anions, is not necessary for achieving high rates of removal with anatase of the present invention. One can appreciate the advantages of present invention by comparing the adsorption on commercial P-25™ from Degussa and on the samples provided by present invention. Another important conclusion which can be drawn from the data shown in FIG. 22 that not just crystallite is size important, but the crystallite size distribution as well. In other words, the spherical approximation of Scherrer equation does not provide a reliable data that could be used for crystallite size distribution.

### EXAMPLE 16

Arsenic Removal from Spiked Tap Water Column Test Using Anatase Sample A glass column with internal diameter of 2 cm was filled with granulated anatase sample prepared as described in FIG. 8 and having 96.5% volume weighted crystallites smaller than 100 Å. Tap water containing about 20 μg/L spiked with arsenic was pumped through the column at an EBCT of about 1.5 minute. As shown in FIG. 26, arsenic concentrations in the treated effluent were less than 10 μg/L, with breakthrough occurring after more than 200,000 bed volumes of water had been treated. There is no experimental or industrial adsorbent, which has comparable characteristics. The best adsorbents, known to date, show many times poorer adsorption during column tests than adsorbents of present invention.

### COMPARATIVE EXAMPLE 1

Adsorption of As(V) Using Anatase From Sigma Aldrich. Anatase titanium dioxide supplied by Sigma Aldrich Corporation, St. Louis, Mo., USA catalog number A248576 with particles size-325 mesh was used to test the adsorption property of this material for removal of arsenic from water. 0.1 gram of material was contacted with 100 ml of artificially spiked with 50 mg/l As(V) water. After three hours the As(V) concentration was determined by Atomic Absorption Spectroscopy (AAS) and found to be 49.94 mg/l or about 0.1%. Thus, anatase titanium dioxide from Sigma-Aldrich was found to be highly inefficient adsorbent of As(V). This experiment shows that the exceptional adsorption properties of anatase samples of present invention for As(V) are achieved not because of the anatase structure or fine particle size, but because of certain crystallite size and their distributions.

### COMPARATIVE EXAMPLE 2

Adsorption of U(VI) using anatase from Sigma Aldrich. Anatase titanium dioxide supplied by Sigma Aldrich Corporation, St. Louis, Mo., USA catalog number A248576 with particles size-325 mesh was used to test the adsorption property of this material for removal of uranium from water. 0.1 gram of material was contacted with 100 ml of artificially spiked with 1000 (g/l U(VI) water. After three hours the U(V) concentration was determined by Kinetic Phosphorescence analyzer (KPA) (ChemChek Instruments) and was found to be 995 mg/l or about 0.5%. Thus, anatase titanium dioxide from Sigma-Aldrich was found to be highly inefficient adsorbent of U(VI). This experiment shows that the exceptional adsorption properties of anatase samples of present invention for U(VI) are achieved not because of that anatase structure or fine particle size, but because of certain crystallite size and their distributions.

### EXAMPLE 17

Preparation of Crystalline Titanium Dioxide of Brookite Structure With D(vol)=35 Å Yellowish and free from precipitates titanium oxychloride solution with 0.25 mol/l concentration is fed by peristaltic pump into a flow reactor which is constantly heated to 105° C. The tube reactor diameter and length were chosen to achieve almost immediate heating of solution to 105° C. This solution was fed using peristaltic pump into the glass tube with 10 mm internal diameter and length placed into constantly heated silicon oil bath with temperature of 105° C. The feed rate was 2 ml per minute. The transparent solution became turbid while moving inside of glass tube. After 30 minute in the heating zone, the suspension was rapidly cooled by dividing it into smaller 0.3 mm diameter tubes cooled by ice filed water bath. Solid titanium oxide suspension was separated by centrifuging of suspension. X-ray powder diffraction analysis showed that the solid consisted entirely of brookite, with broad diffraction lines. Crystallite size determined by Scherrer equation was 37 Å. Crystallite size distribution determined by Warren-Averbach method is shown in FIG. 13. Volume weighted crystallites size was 35 Å and more than 96.4 percent of crystals were smaller than 100 Å. The sample was determined to have a BET specific surface area of about 370 m²/gm and a total pore volume of 0.45 cm³/gm for pores with diameters less than 0.7 μm. Yield of titanium dioxide was 24 weight percent.

### EXAMPLE 18-23

Preparation of Crystalline Titanium Dioxide of Brookite Structure with Different Crystallite Sizes. Crystallite Size Distribution Analysis. The same solution used in experiment of Example 17 was treated in similar fashion by varying the time of heating, which was easily achieved by adjusting pumping rate. Solid samples separated from suspensions were analyzed using powder diffraction. Some samples were heated at various temperatures. Powder diffraction patterns of these samples are illustrated in FIG. 6. Crystallite size distributions of the obtained samples are shown in FIG. 13, FIG. 14, and FIG. 15.

### EXAMPLE 24

Batch Adsorption of As(V) and As(III) From Spiked Tap Water. Brookite samples obtained in examples 17-23 were used to determine adsorption properties of various samples. Aqueous samples of the arsenate (As(V)) and arsenite (As(III)) were prepared for testing by dissolving salts of the selected substances in tap water to the initial concentrations of 50 mg/l. Batch experiments were conducted by adding the brookite samples to each aqueous sample, to obtain the titanium oxide concentration of 1 g/l and suspending the brookite powder in the aqueous sample by mixing for about three hours. The results (FIG. 22) show that brookite not only effectively removes As(V), but also As(III) in a relatively short time, i.e., three hours or less. The high degree of arsenite (As(III)) removal is particularly noteworthy, since conventional adsorbents, such as alumina or ferric hydroxide, are known to have much lower capacities for removal of this oxyanion. It is also important to note that, the conversion of As(III) to As(V) and its adsorption are achieved on samples containing the higher percentage of smaller crystals. One can appreciate the advantages of present invention by comparing the adsorption on commercial P-25™ from Degussa and the samples provided by present invention. Another important conclusion can be drawn from data shown in FIG. 23 that the crystallite size distribution is more important than crystallite size. In other words, the spherical approximation of Scherrer equation does not provide a reliable data that could be used for crystallite size distribution.

### EXAMPLE 25

Freshly prepared and not dried (wet) amorphous titanium dioxide is dissolved in nitric acid to form a transparent and free from precipitates solution. The molar ratio of component in the solution is Ti: HNO₃: H₂O=0.02:0.04:60. The transparent and free from precipitates titanium nitrate solution is fed by peristaltic pump into a flow reactor which was constantly heated to 50° C. The tube reactor diameter and length were chosen to achieve almost immediate heating of solution to 50° C. The pumping rate was adjusted in such a way that the time of hot solution in a flow reactor varied from 10 to 60 minutes. This solution was fed using peristaltic pump into the glass tube with 10 mm internal diameter and length placed inside the constantly heated silicon oil bath with temperature of 50° C. The feed rate was 2 ml per minute. The transparent solution became turbid while moving inside the glass tube. After about 10 minute in the heating zone, the suspension was rapidly cooled by dividing it into smaller 0.3 mm diameter tubes cooled by ice filed water bath. Solid titanium oxide was separated by centrifuging of suspension. X-ray powder diffraction analysis showed that the solid consisted entirely of anatase, with broad diffraction lines. Crystallite size determined by Scherrer equation was 66 Å. Crystallite size distribution determined by Warren-Averbach method is shown in FIG. 16. Volume weighted crystallites size was 75 Å and more than 73.1 percent of crystals were smaller than 100 Å. The sample was determined to have a BET specific surface area of about 210 m²/gm and a total pore volume of 0.32 cm³/gm for pores with diameters of less than 0.45 μm. Yield of titanium dioxide was 29 weight percent.

### EXAMPLE 26-31

The same solution used in experiment of Example 25 was treated in similar fashion by varying the time of heating, which was easily achieved by adjusting pumping rate. The solid samples separated from suspensions were analyzed using powder diffraction. Some samples were heated at various temperatures. Powder diffraction patterns of these samples are illustrated in FIG. 7. Crystallite size distributions of the obtained samples are shown in FIG. 16, FIG. 17, and FIG. 18. Comparative analysis of P-25™ from Degussa is shown in FIG. 12.

### EXAMPLE 32

Batch Adsorption of As(V) and As(III) From Spiked Tap Water. Rutile samples obtained in examples 25-31 were used to determine adsorption properties of various samples. Aqueous samples of the arsenate (As(V)) and arsenite (As(III)) were prepared for testing by dissolving salts of the selected substances in tap water to the initial concentrations of 50 mg/l. Batch experiments were conducted by adding the rutile samples to each aqueous sample, to obtain the titanium oxide concentration of 1 g/l and suspending the rutile powder in the aqueous sample by mixing for about three hours. The results (FIG. 24) show that rutile not only effectively removes As(V), but also As(III) in a relatively short time, i.e., three hours or less. The high degree of arsenite (As(III)) removal is particularly noteworthy, since conventional adsorbents, such as alumina or ferric hydroxide, are known to have much lower capacities for removal of this oxyanion. It is also important to note that the conversion of As(III) to As(V) and its adsorption are achieved on samples containing the higher percentage of smaller crystals. These tests demonstrated that presence of chloride, or of other acidic anions, is not necessary for achieving high rates of removal with rutile of the present invention. One can appreciate the advantages of present invention by comparing the adsorption on commercial P-25™ from Degussa and the samples provided by present invention. Another important conclusion can be drawn from data shown in FIG. 24 that not only crystallite size is important, but the crystallite size distribution is even more important. In other words, the spherical approximation of Scherrer equation does not provide a reliable data that could be used for crystallite size distribution.

### COMPARATIVE EXAMPLE 3

Rutile titanium dioxide supplied by Sigma Aldrich Corporation, St. Louis, Mo., USA catalog number A224227 with particles size 5 micron was used to test the adsorption property of this material for removal of arsenic from water. 0.1 gram of material was contacted with 100 ml of water artificially spiked with 50 mg/l As(V). After three hours As(V) concentration was determined by Atomic Absorption Spectroscopy (AAS) and was found to be 49.99 mg/l or about 0.02%. Thus, rutile titanium dioxide from Sigma-Aldrich was found to be highly inefficient adsorbent of As(V), practically not capable of adsorbing any quantity of dissolved arsenic. This experiment shows that the exceptional adsorption properties of rutile samples of present invention for As(V) are achieved not because of the rutile structure or fine particle size, but because of certain crystallite size and their distributions.

### COMPARATIVE EXAMPLE 4

Rutile titanium dioxide supplied by Sigma Aldrich Corporation, St. Louis, Mo., USA catalog number A224227 with particles size 5 micron was used to test the adsorption properties of this material for removal of arsenic from water. 0.1 gram of material was contacted with 100 ml of water artificially spiked with 1000 g/l U(VI). After three hours the U(VI) concentration was determined by Kinetic Phosphorescence analyzer (KPA) (ChemChek Instruments) and was found to be 998 g/l or about 0.2%. Thus, rutile titanium dioxide from Sigma-Aldrich was found to be highly inefficient adsorbent of U(VI), practically not capable of adsorbing any quantity of dissolved uranium. This experiment shows that the exceptional adsorption properties of rutile samples of present invention for U(VI) are achieved not because of the rutile structure or fine particle size, but because of certain crystallite size and their distributions.

### EXAMPLE 33

Arsenate Adsorption on Mixtures. Batch adsorption of As(V) from spiked tap water. Various samples with known phase quantities determined by Rietveld quantification method and crystallite size distribution method described earlier (FIG. 20 and FIG. 22) and obtained mostly during rutile synthesis procedures were used for determination of adsorption properties of these mixtures. Aqueous samples of arsenate (As(V)) were prepared for testing by dissolving salts of the selected substances in tap water to the initial concentrations of 50 mg/l. Batch experiments were conducted by adding the mixture samples to each aqueous sample, to obtain the titanium oxide concentration of 1 g/l and suspending the rutile powder in the aqueous sample by mixing for about three hours. The results (FIG. 25) show that the mixtures of samples were as effective in absorption as pure-phase samples.

All publications and patent applications mentioned in this specification are indicative of the level of skill of those in the art to which the invention pertains. All publications and patent applications are herein incorporated by reference to the same extent as if each individual publication or patent application were specifically and individually indicated to be incorporated by reference in its entirety.

Although the foregoing invention has been described in some detail by way of illustration and example for purposes of clarity of understanding, it will be readily apparent to those of ordinary skill in the art in light of the teachings of this invention that certain changes and modifications may be made thereto to adapt it to various usages and conditions without departing from the spirit or scope of the invention, as defined by the appended claims.

### REFERENCES CITED

U.S. Patent Documents

U.S. Pat. No. 6,383,395; May 7, 2002. Water treatment method and apparatus. S. R. Clarke et al.
U.S. Pat. No. 5,618,437; Apr. 8, 1997. Process for removing sulphate from aqueous solution. J. G. Ulan et al.
U.S. Pat. No. 5,227,053; Jul. 13, 1993. Water purification system. S. J. Brym
U.S. Pat. No. 4,268,399; May 19, 1981. Purification of polluted water. Jr. Box et al.
U.S. Pat. No. 4,304,687 Dec. 8, 1981 Catalyst for the purification of polluted water, Jr. Box et al.
U.S. Pat. No. 4,892,712; Jan. 9, 1990, Fluid purification. M. K. Robertson et al.
U.S. Pat. No. 3,332,737; Jul. 25, 1967. Process for separating inorganic anions with hydrous oxide anion exchangers. K. A. Kraus
U.S. patent application Publication No. 20030155302 A1; Aug. 21, 2003. Methods of preparing a surface-activated titanium oxide product and of using same in water treatment processes. X. Meng et al.
U.S. Pat. No. 1,333,819; Mar. 16, 1920. Process of extracting titanium compounds from titaniferoius material and the product obtained thereby. G. Jensen
U.S. Pat. No. 6,001,326; Dec. 14, 1999. Method for producing of monodispersed and crystalline TiO2 powders for aqueous TiOCl₂ solution using homogeneous precipitation. S.-J. Kim et al.
U.S. patent application Publication No. 6,517,804 B1; Feb. 11, 2003. TiO₂ ultrafine powder, and process for preparing thereof. S.-J. Kim et al.
U.S. Pat. No. 6,300,559 B1; Oct. 9, 2001. Bye-sensitization-type photoelectric conversion element. M. Ohmori
U.S. Pat. No. 6,340,711 B1; Jan. 22, 2002. Particles aqueous dispersion and film of titanium oxide and preparation thereof. M. Ohmori.
   Foreign Patent Documents
Japanese Patent Application Publication No. 58-45705
Japanese Patent Application Publication No. 57-150481
Japanese Patent Application Publication No. 53-122691
Publication WO 03/068682

### OTHER REFERENCES

Swope, R. J., Smyth, J. R., Larson, A. C. H in rutile-type compounds: I. Single-crystal neutron and X-ray diffraction study of H in rutile, American Mineralogist, 80, 448-453, (1995).
Photocatalysis over TiO₂ Supported on a Glass Substrate”, SOLAR ENERGY MATERIALS, 14:121-127 (North Holland Amsterdam 1986).
R. W. Mathews, “Solar-Electric Water Purification Using Photocatalytic Oxidation with TiO₂ as a Stationary Phase”, SOLAR ENERGY, 38:405-413 (1987),
M. Bissen and et.al. TiO₂-catalazed photooxydation of arsenite to arsenate in aqueous samples, Chemosphere 44 (2001) 751-757.
Kirk-Othmer's Encyclopedia of Chemical Technology, 3rd Edition, Vol. 23 at pp. 143-148.
H. Yin and et al. Novel synthesis of nanosized anatase and rutile TiO₂ using amorphous phase TiO₂. Chemistry of Materials 2002, 12, 378-383
M. Gopal and et al Journal of Materials Science, 1997, 32, 6001-6008
Z. Tang and et al Synthesis of nanosized rutile TiO₂ powder at low temperature. Materials Chemistry and Physics 2002, 77, 314-317.
M. Kiyama and et al Chem. Letters, 1972, 21
B. Ohtani and et al Chemical Physics Letters, 1985, 120, No. 3, 292-294.
Pottier et al. Synthesis of brookite TiO₂ nanoparticles by thermolysis of TiCl₄ in strongly acidic aqueous media. Journal of Materials Chemistry, 2001, 11, 1116-1121
ICSD (Inorganic Crystal Structure Database, Fachinformationszentrum Karlsruhe, Germany (FIZ) and The National Institute of Standards and Technology, Gaithersburg, Md. USA (NIST), version 1.3.1, 2003)
Howard, C. J.; Sabine, T. M.; Dickson, F. Structural and Thermal Parameters for Rutile and Anatase Acta Crystallographica B 47, 462-468 (1991).
PDF2 database published by ICDD (The International Centre for Diffraction Data) Newtown Square, Pa., USA
Meagher, E. P.; Lager, G. A Polyhedral thermal expansion in the TiO₂ polymorphs. Canadian Mineralogist 17, 77-85 (1979).
Howard, C. J.; Sabine, T. M.; Dickson, F. Structural and Thermal Parameters for Rutile and Rutile Acta Crystallographica B 47, 462-468(1991).
Reitveld method Editor R. A. Young, Oxford University Press, 1993
Generalized Structure Analysis System, by A. C. Larson and R. V. Dreele, LANSCE, MS-H805, Los Alamos National Laboratory, Los Alamos, NMN 87545 USA
B. E. Warren, X-ray Diffraction, Addison Wesley, Reading, MA, 1969;
H. P. Klug and L. E. Alexander, X-ray Diffraction Procedures, 2nd edition, John Wiley, New York, 1974).
D. Balzar and H. Ledbetter, J. Appl. Cryst. 26 (1993) 97-103
D. Balzar, J. Res. Natl. Inst. Stand. Technol. 98 (1993) 321-353.
Sigma Aldrich Corporation, St. Louis, Mo., USA CATALOG 2004-2005

1. An adsorbent for removal or concentration or retention and recovery of harmful or valuable dissolved ions and compounds from aqueous systems, comprising a crystalline titanium dioxide having a crystalline structure selected from the group consisting of anatase, brookite and rutile, wherein the volume weighted crystallite diameter of at least 15 percent of said titanium dioxide crystals is less than 100 Å and which upon contact with said aqueous systems are producing bound to the surface terminal titanium atoms self-generated surface hydroxyl groups which are reactive towards said dissolved materials.

2. The adsorbent of claim 1, characterized in that the titanium dioxide has a structural formula [MeO₂]ₐ[TiO_{5/3}(OH)]_{b}[TiO_{4/3}(OH)₂]_{c}[TiO_{3/3}(OH)₃]_{d}[TiO_{2/3}(OH)₄]ₑ[TiO_{1/5}(OH)₅]_{f}[H₂O]ₙ}, herein Me is comprising an octahedrally coordinated atom selected from the group consisting of titanium, zirconium, niobium, tin, germanium, silicon, aluminum, wherein the following relationship exists: 8≦(a+b+c+d+e+f)≦35000; 7<(b+c+d+e+f)≦7000 and n≦(b+c+d+e+f).

3. The adsorbent of claim 1, wherein said titanium dioxide is (a) in powdered, granulated, and molded or mixtures of thereof form; (b) in colloid suspension or sol form; (c) is in the form of coating of support materials or mixture with supporting material.

4. The support material of claim 3 is selected from the group consisting of inorganic, organic materials, oxides, hydroxides, mixed oxides, salts, alumina, silica, titania, diatomite, naturally occurring, man made materials, activated carbon and polymers.

5. A process for preparing the crystalline titanium dioxide having a structure selected from the group consisting of anatase, brookite and rutile, wherein the volume weighted crystallite diameter of at least 15 percent of said titanium dioxide crystals is less than 100 Å, and reactive hydroxyl groups on terminal titanium atoms, comprising the steps of: (i) heating of solution comprising hydrolysable titanium compound to initiate spontaneous or seed assisted nucleation and formation of structure selected from the same group; (ii) determination of the crystallite size and crystallite size distribution; (iii) termination of crystal growth of said titanium dioxide crystals upon reaching of required sizes; (iv) separation of obtained crystalline titanium dioxide from crystallization media, washing and adequately drying at certain temperatures to avoid or minimize the crystallite size increase.

6. The process of claim 5, wherein said hydrolysable titanium compound is selected from the group of compounds consisting of titanium trichloride, titanium tetrachloride, titanium oxychloride, titanium nitrate, titanyl sulfate, titanium sulfate, titanium oxysulfate, titanium iron sulfate solution, titanium ethoxide, titanium isobutoxide, titanium isopropoxide, and titanium methoxide.

7. The process of claim 5, wherein said crystallite size and crystallite size distribution is determined by using of X-ray powder diffraction data treated by Scherrer's equation or Warren-Averbach method or similar Fourier methods.

8. The process of claim 5, wherein said termination of titanium dioxide crystal growth is effected by means selected from the group consisting of cooling, limited supply of said hydrolysable titanium compound solution, limited duration of crystallization.

9. The process of claim 9, wherein said hydrolysis of hydrolysable titanium compound is conducted in the presence of support material.

10. The process of claim 9, wherein said hydrolysis is performed in a manner that formed titanium oxide crystals are adhering to said support material.

11. The process for the preparation of a high-porosity adsorbent loaded with titanium dioxide of claim 1 which comprises the steps of: (i) bringing a porous support material into contact with an hydrolysable solution containing a titanium compound so as to impregnate the pores of the porous support material with the hydrolysable titanium containing solution; (ii) heating the porous support material impregnated with said solution to give a porous material loaded with the titanium dioxide.

12. The process of claim 18, wherein said porous material support material is selected from the group consisting of microporous and mesoporous materials.

13. The process of claim 18, wherein the porous support material has a specific surface area in the range from 10 to 1600 m²/g and average pore diameter greater than 0.5 nm.

14. A method for removal or concentration or retention and recovery of harmful or valuable dissolved ions and compounds from aqueous systems, which comprises the step of contacting said aqueous systems with adsorbent comprising of a large band gap semiconductor crystalline titanium dioxide having a structure selected from the group consisting of anatase, brookite, rutile with crystallite size of at least of 15% of crystals are less than 100 angstrom and which generate the reactive towards said dissolved ions and compounds surface hydroxyl groups upon contacting said titanium dioxide crystals with aqueous systems and said hydroxyl groups will react with said dissolved ions and compounds to bind them into the surface of adsorbent.

15. The method of claim 21, wherein said aqueous systems are selected from group consisting of water, ground water, surface water, drinking water, wastewater, water solutions, water vapor, water of aquifer, lake water, rain water, water containing matrixes, water containing soils, water containing powders, contaminated water, tea, coffee, drinks containing water, acidic water, basic water.

16. The method of claim 21, wherein said dissolved ions and compounds comprise a dissolved compounds of chemical elements of periodic table selected from the group consisting of aluminum, antimony, arsenic(III), arsenic(V), phosphorous, barium, cadmium, cesium, chromium, cobalt, copper, gallium, gold, iron, lead, manganese, mercury, molybdenum, nickel, platinum, radium, selenium, silver, strontium, tellurium, tin, tungsten, uranium, transuramic elements, vanadium, zinc, nitrite, phosphate, sulfite, sulfide, fluoride and a low-molecular weight organic arsenic compounds, monomethylarsonic acid, dimethylarsonic acid, and phenylarsonic acid.

17. The method of claim 21, wherein said dissolved materials comprise dissolved radionuclides.

18. The method of claim 24, wherein said radionuclides are selected from the groups consisting of alpha emitters, beta emitters, gamma emitters and positron emitters.

19. A method of preparing a solution of carrier-free radionuclide comprising the steps of: (a) providing a generator column loaded with adsorbent of claim 1 with adsorbed parent radionuclide; (b) eluting the daughter radionuclide from the generator column with an elution solution.

20. The method of claim 26, wherein said parent radionuclide is selected from the group consisting of ⁹⁹Mo and ¹⁸⁸W and said daughter radionuclide is selected from the group consisting of ^{99m}Tc and ¹⁸⁸Re.
